(19) United States
(12) Patent Application Publication
(10) Pub. No.: US 2026/0038047 A1
(43) Pub. Date: Feb. 5, 2026

(54) SYSTEMS AND METHODS FOR LIQUIDITY MATCHING

(71) Applicant: JPMORGAN CHASE BANK, N.A., New York, NY (US)

(72) Inventors: Richard TOVEY, Salisbury (GB); Phillip APPLEGATE, Eastleigh (GB); Amanpreet RANA, Welling (GB); Richard PLATER, New York, NY (US); Gopal K BHARUKA, Thane (GB); Michael BELLAMY, Verwood (GB); Lawrence Charles DRAKE, Bournemouth (GB); Daniel McCULLAM, New York, NY (US); Priyan MANICKAVASAGAM, New York, NY (US)

(21) Appl. No.: 19/289,507

(22) Filed: Aug. 4, 2025

Related U.S. Application Data
(60) Provisional application No. 63/678,859, filed on Aug. 2, 2024.

(51) Int. Cl. G06Q 40/06

(52) U.S. Cl. CPC G06Q 40/06

(57) ABSTRACT

A method may include: a funds control workflow orchestrator computer program receiving, from a money movement platform, a funds control request for a transaction for a client; the funds control workflow orchestrator computer program requesting funding for the request from a liquidity matching computer program; the funds control workflow orchestrator computer program determining whether the request can be funded based on account balances for the client retrieved from an account ledger or an approved credit extension; the liquidity matching computer program generating a liquidity snapshot for the client and storing the liquidity snapshot in an available liquidity snapshot store; the funds control workflow orchestrator computer program receiving a positive determination on liquidity; the funds control workflow orchestrator computer program returning the positive determination to the money movement platform, wherein the money movement platform executes the transaction; and the funds control workflow orchestrator computer program updating a workflow status.

### RELATED APPLICATIONS

This application claims priority to, and the benefit of, U.S. Provisional Patent Application Ser. No. 63/678,859, filed Aug. 2, 2024, the disclosure of which is hereby incorporated, by reference, in its entirety.

### BACKGROUND OF THE INVENTION

### 1. Field of the Invention

Embodiments relate to systems and methods for liquidity matching.

### 2. Description of the Related Art

In finance, making a payment, or requesting a transfer of funds from an account, requires there to be sufficient “liquidity” in the source account. Liquidity can be thought of as the available balances on the client's accounts plus any available credit that the bank is willing to lend to the client. Credit lines are often shared across multiple bank accounts held by a client with a bank branch.

Liquidity is often dispersed across multiple accounts, of varying types (currencies, asset classes, etc.), associated with multiple bank branches and owned by multiple legal entities. No individual account may have sufficient liquidity to fund a debit.

A client may decide to fund an important debit by notionally sharing balances across an account structure (potentially enabled by foreign exchange or liquidating assets). Notional balance sharing (or lending/borrowing) has the effect of reducing (or increasing) the available account balance (or funding “supply”) without altering the lending account's balance; however notional lending will reduce the lending account's available balance by the amount lent.

Large and multinational clients often have complex legal structures comprising of many layers of legal entities, sometimes internationally domiciled, and each with multiple bank accounts which may establish banking relationships with multiple bank branches of a global bank in different countries and time zones. Clients may hold cash deposits, denominated in many global currencies or other liquid asset classes (e.g., precious metals, cryptocurrencies, securities and loyalty points) with an equivalent cash value.

Clients with complex legal entity and account structures may need to define a preferential hierarchy of liquidity sources and establish limits that control how liquidity moves across their account structure to comply with regulations and maintain a stable balance sheet.

The process of assessing whether a client has sufficient liquidity to deduct funds from their account is known as “funds control.” The decision is intended to protect both the bank and client from any unintended or unauthorized financial liabilities (above those already pre-approved). Money movements may be held at funds control due to insufficient liquidity. Such movements will be blocked from completing and consequently delayed. This can have significant implications for the client and the wider financial system where these money movements are very large in value, significant to the wider economy (e.g., a significant merger and acquisition transaction, etc.), or being made on behalf of clients of another financial institution, as in the correspondent banking system.

At any given time, the multinational organization's overall liquidity may be unevenly distributed, resulting in some of the client's accounts having a very high level of liquidity and others having little. This can cause treasury management funding challenges for the client when one subsidiary has an important money movement that they need to make but the holistic liquidity of the client is held by a different subsidiary in a different account and bank branch. Without notional borrowing, the client treasury will need to move the funds to the account where they are required to unblock the payment.

### SUMMARY OF THE INVENTION

Systems and methods for liquidity matching are disclosed. In one embodiment, a method may include: receiving, by a funds control workflow orchestrator computer program executed by an electronic device and from a money movement platform, a funds control request for a transaction for a client; requesting, by the funds control workflow orchestrator computer program, funding for the request from a liquidity matching computer program; determining, by the liquidity matching computer program, whether the request can be funded based on account balances for the client retrieved from or synchronized with an account ledger or a credit line or an approved credit line extension; generating, by the liquidity matching computer program, a liquidity snapshot for the client and storing the liquidity snapshot in an available liquidity snapshot store; receiving, by the funds control workflow orchestrator computer program, a positive determination on liquidity; returning, by the funds control workflow orchestrator computer program, the positive determination to the money movement platform, wherein the money movement platform executes the transaction; and updating, by the funds control workflow orchestrator computer program, a workflow status.

The money movement platform may post the completed and settled money movement event as a posting to the account ledger(s).

In one embodiment, the step of determining whether the request can be funded may include: retrieving, by the liquidity matching computer program, a prior liquidity snapshot from the available liquidity snapshot store; extracting, by the liquidity matching computer program, current liquidity information from the prior liquidity snapshot; executing, by the liquidity matching computer program, a debit funding algorithm to identify debits to fund; updating, by the liquidity matching computer program, the current liquidity information; serializing, by the liquidity matching computer program, the updated current liquidity information; persisting, by the liquidity matching computer program, the serialized updated current liquidity information in the available liquidity snapshots store; and forwarding, by the liquidity matching computer program, the updated current liquidity information to a ledger reconciliation computer program.

In one embodiment, the method may also include matching, by the ledger reconciliation computer program, a completed ledger posting event with the funds control request and notifying the liquidity matching computer program as required, to ensure that all account ledger activity is reflected in the balances used by the liquidity matching computer program.

In one embodiment, the prior liquidity snapshot may include available balances, balance sharing rules, funding source priorities, notional borrowing/lending amounts and limits, remaining notional borrowing/lending limits, and/or remaining credit line amounts.

In one embodiment, the method may also include: applying, by the liquidity matching computer program, credits (“receipts”) to the current liquidity information; and returning, by the liquidity matching computer program, cash for partially funded debits from a previous cycle as available credit to a balance sharing group for re-use.

In one embodiment, the liquidity matching computer program processes the request as a plurality of micro-batches. The computer program may process multiple micro-batches concurrently to improve throughput and hardware utilization.

In one embodiment, the method may also include requesting, by the funds control workflow orchestrator computer program, a credit line from a credit extension approval system in response to a negative determination on liquidity.

In one embodiment, the step of determining whether the request can be funded may include: verifying, by the liquidity matching computer program, that the request is not a duplicate; transferring, by the liquidity matching computer program, the request to an in-memory queue; collecting, by the liquidity matching computer program, an account and credit line structure for a balance sharing group for the client from a prior liquidity snapshot; constructing, by the liquidity matching computer program, a mathematical graph representing a current notional borrowing position for the client; determining, by the liquidity matching computer program, an optimal repayment of notional borrowing and lending using a maximum flow with minimum cost algorithm; constructing, by the liquidity matching computer program, a mathematical graph that represents a current liquidity position of a balance sharing group for the client; determining, by the liquidity matching computer program, optimal funding decisions using the mathematical graph that represents the current liquidity, permitted notional borrowing/lending and notional borrowing/lending priorities and limits of the balance sharing group; updating, by the liquidity matching computer program, account balances, available balances, remaining credit line amounts, notional borrowing/lending amounts and remaining limits in the balance sharing group; serializing, by the liquidity matching computer program, the account balances, available balances, remaining credit line amounts, notional borrowing/lending amounts and remaining notional borrowing/lending limits and persisting the serialized account balances, available balances, remaining credit line amounts, notional borrowing/lending amounts and remaining notional borrowing/lending limits; and publishing, by the liquidity matching computer program, approved liquidity matches to a ledger reconciliation computer program.

In one embodiment, the step of determining whether the request can be funded may include: verifying, by the liquidity matching computer program, that the request is not a duplicate; splitting, by the liquidity matching computer program, a credit balance into credit chunks; matching, by a thread executed by the liquidity matching computer program, the debit request with one or more of the credit chunks; capturing, by the liquidity matching computer program, a state of a liquidity order book; and responding, by the liquidity matching computer program, to the money movement platform with the state.

In one embodiment, the method may also include replenishing, by the liquidity matching computer program, liquidity with additional funds.

According to another embodiment, a system may include: a money movement platform; an account ledger; and a funds control system comprising: a funds control workflow orchestrator computer program; a liquidity matching computer program; and an available liquidity snapshots store. The funds control workflow orchestrator computer program may be configured to receive a funds control request for a transaction for a client from the money movement platform; the funds control workflow orchestrator computer program may be configured to request funding for the request from the liquidity matching computer program; the liquidity matching computer program may be configured to determine whether the request can be funded based on account balances for the client retrieved from or synchronized with the account ledger or a credit line or an approved credit extension; the liquidity matching computer program may be configured to generate a liquidity snapshot for the client and to store the liquidity snapshot in the unposted liquidity snapshots store; the funds control workflow orchestrator computer program may be configured to receive a positive determination on liquidity; the funds control workflow orchestrator computer program may be configured to return the positive determination to the money movement platform; the money movement platform may be configured to execute the transaction; and the funds control workflow orchestrator computer program may be configured to update a workflow status.

The money movement platform may be configured to post the completed and settled money movement event as a posting to the account ledger(s).

In one embodiment, the liquidity matching computer program may be further configured to determine whether the request can be funded by: retrieving a prior liquidity snapshot from the available liquidity snapshot store; extracting current liquidity information from the prior liquidity snapshot; executing a debit funding algorithm to identify debits to fund; updating the current liquidity information; serializing the updated current liquidity information; persisting the serialized updated current liquidity information in the available liquidity snapshots store; and forwarding the updated current liquidity information to a ledger reconciliation computer program.

In one embodiment, the ledger reconciliation computer program may be further configured to match a completed ledger posting event with the funds control request and notifying the liquidity matching computer program as required, to ensure that all account ledger activity is reflected in the balances used by the liquidity matching computer program.

In one embodiment, the prior liquidity snapshot may include available balances, balance sharing rules, funding source priorities, notional borrowing/lending amounts and limits, remaining notional borrowing/lending limits, and/or remaining credit line amounts.

In one embodiment, the liquidity matching computer program may be configured to apply credits (“receipts”) to the current liquidity information; and the liquidity matching computer program may be configured to return cash for partially funded debits from a previous cycle as available credit to a balance sharing group for re-use.

In one embodiment, the liquidity matching computer program may be configured to processes the request as a plurality of micro-batches. The computer program may process multiple micro-batches concurrently to improve throughput and hardware utilization.

In one embodiment, the funds control workflow orchestrator computer program may be further configured to request a credit line from a credit extension approval system in response to a negative determination on liquidity.

In one embodiment, the liquidity matching computer program may be configured to determine whether the request can be funded by: verifying that the request is not a duplicate; transferring the request to an in-memory queue; collecting an account structure for a balance sharing group for the client and a prior liquidity snapshot; constructing a mathematical graph representing a current notional borrowing position for the client; determining an optimal repayment of notional borrowing and lending using a maximum flow with minimum cost algorithm; constructing a mathematical graph that represents a current liquidity position of a balance sharing group for the client; determining optimal funding decisions using the mathematical graph that represents the current liquidity, permitted notional borrowing/lending and notional borrowing/lending priorities and limits of the balance sharing group; updating the account balances, available balances, remaining credit line amounts, notional borrowing/lending amounts and remaining notional borrowing/lending limits of the balance sharing group; serializing and then persisting the account balances, available balances, remaining credit line amounts, notional borrowing/lending amounts and remaining notional borrowing/lending limits; and publishing approved liquidity matches to a ledger reconciliation computer program.

In one embodiment, the liquidity matching computer program may be configured to determine whether the request can be funded by: verifying that the request is not a duplicate; splitting a credit balance into credit chunks; matching the debit request with one of the credit chunks; capturing a state of a liquidity order book; and responding to the money movement platform with the funding decision.

In one embodiment, the liquidity matching computer program may be further configured to replenish liquidity with additional funds.

Embodiments may use a multi-threaded liquidity markets approach for high-throughput, low-latency funds control decision processing. In embodiments, a positive account balance may be split into many smaller amounts, which sum to the balance amount. By splitting the credit amounts into chunks, it becomes possible to increase the number of threads which can “lock” on funds to match available funds for a funds control debit request.

The size of the chunks may be determined according to the expected number of concurrent requests.

A request for debit funds may be matched with available credits. Any left-over funds are appended and tracked as an additional credit amount.

A process may run periodically, or as required, to consolidate credits together to deal with fragmentation of the credit balance into smaller amounts.

The multi-threaded liquidity market may be paired with a micro-batching algorithm powered liquidity cycle, enabling requests which require a higher throughput and lower latency (e.g., instant payments) to be processed by the liquidity matching market. The liquidity matching market may be topped up with additional funds or return funds to the liquidity cycle according to configured high/low balance limits. A liquidity allocation monitor may keep track of this liquidity matching market balance and may initiate the movement of funds.

Many liquidity cycles may be networked with many liquidity matching markets to enable notional balance sharing between accounts, subject to notional borrowing and lending rules.

Real-time ledger synchronization is disclosed. In one embodiment, funds control may be a distinct/separate system for multiple account ledgers (which record the statement client account activity), while retaining a real-time position synchronization by receiving events of ledger activity, matching this activity to funded funds control responses and adjusting the funds control available balance when required to maintain synchronization of the available balance.

The ledger reconciliation activity may keep track of any in-flight, unposted activity. By following a similar micro-batching approach to the liquidity matching computer program, high-throughput processing with multi-region resiliency can be achieved by repeatedly storing unmatched postings as linked, signed and encrypted binary snapshots.

Embodiments may use a consistent hashing algorithm that may shard unmatched postings across multiple data objects/database rows to mitigate limits on the maximum database row size and reduce the amount of data requiring modification when used to partition unmatched postings across multiple database rows/data objects.

Embodiments may provide consistent hash-based partitioning and sharding of funds control processing. In embodiments, funds control workloads may be divided into multiple isolated full-system deployment partitions. Clients may use a consistent hashing algorithm, based on a well-known data attribute (like the client identifier of the account) that can be used as a sharding key, to determine which partition to route requests to for processing. This may limit the overall impact of a partition wide issue to a smaller number of clients and may give greater flexibility and options for upgrades, releases and maintenance.

In embodiments, a system partition may be horizontally scaled by further dividing the partition workload across one or more shards. A smart load balancer, or an intelligent client interface, can route the requests to the shard responsible for processing the requests for the account (e.g., based on the client identifier of the account). Shard node Internet Protocol addresses may be retrieved from a central reliable service, like a domain name service (DNS). Routing requests to a shard node enables prioritization of simultaneous requests and reduces latency without introducing a potential single point of failure. This may also help to avoid the need for a large and complex routing table that would need to be updated/maintained across a potentially large, distributed set of components within the system.

Workloads may be migrated between deployment partitions using an API when the sharding key changes (e.g., the owner of an account changes).

Embodiments may use a funds control authorization token, such as a cryptographically signed and encrypted digital authorization token that may be issued by the funds control liquidity matching computer program. This may encode information about the approved money movement, client account identifier and a funds control approval expiry time.

By distributing public decryption and signing keys to trusted systems involved in the management and orchestration of money movements, other applications may reliably interpret the funds control decision without having to directly connect to the funds control system to corroborate the information. This may improve efficiency, scalability and reduces the load and availability requirements of the funds control system.

Associated systems may use the funds control authorization token to enforce policy (e.g., ensuring the client has sufficient funds before moving cash externally via a third-party clearer, enforcing renewal of aging funds control request approvals, distributed event tracing and duplicate detection). This may improve the consistency, integrity, manageability and security of the wider distributed financial system.

Embodiments may apply low-latency probabilistic duplicate detection. Probabilistic data structures (e.g., Bloom filters) may be incorporated into the funds control liquidity matching computer program as a low-latency and high-throughput idempotency check to filter out duplicate requests which were previously approved/balance impacting. Enabling duplicate checking to take place within the liquidity matching computer program process, without requiring a slow, potentially blocking operation to check against an external database/cache. This may help ensure consistent low-latency processing.

The probabilistic data structures may be dynamically sized and/or shared across multiple accounts which are liquidity matched on the same liquidity matching computer program instance to achieve a balance between memory, false positive rate and capacity based on historic account/balance sharing structure activity and the desired duplicate checking sliding time window. This enables memory usage to be optimized by avoiding the inefficient over-allocation of memory to accounts/balance sharing structures which have limited activity.

The ledger reconciliation computer program may act as a helper sidecar to prepare and rotate new probabilistic data structures based on a sliding historic window (e.g., the past 24 hours of activity) and assess potential false positives (which may be forcibly handled by the liquidity matching computer program). This may enable the liquidity matching computer program to be optimized for high performance/low latency, by reducing memory allocation and garbage collection demands when implemented on computer languages/runtimes which make use of garbage collectors for memory management.

Embodiment may use a monotonically increasing sequence number that represents the evolving state of the liquidity matching computer program in the messages to the ledger reconciliation computer program. This may enable the evaluation of false positives on the ledger reconciliation computer program to handle a potential race condition (e.g., sequential duplicate which is not yet known by the ledger reconciliation computer program).

In embodiments, the liquidity matching computer program may maintain a temporal cache of recently approved/balance impacting requests during a probabilistic filter rotation/refresh to enable any requests approved during the time when the new filter is being generated to be subsequently incorporated into the new filter after it has been created and before it replaces the current/prior filter for duplicate checking. This avoids having to stop processing requests for an extended time while the new idempotency filter is being generated and changed.

### BRIEF DESCRIPTION OF THE DRAWINGS

For a more complete understanding of the present invention, the objects, and advantages thereof, reference is now made to the following descriptions taken in connection with the accompanying drawings in which:

FIG. 1 illustrates a system for liquidity matching according to an embodiment;

FIGS. 2A-2C illustrate a method for liquidity matching according to an embodiment;

FIG. 3 illustrates a method for liquidity matching according to another embodiment;

FIG. 4 illustrates a method for liquidity matching according to another embodiment;

FIGS. 5A and 5B illustrates a method for liquidity matching according to another embodiment;

FIGS. 6A-6D are illustrations of steps of a method for liquidity matching according to an embodiment;

FIG. 7 depicts an exemplary computing system for implementing aspects of the present disclosure.

### DETAILED DESCRIPTION OF PREFERRED EMBODIMENTS

Systems and methods for liquidity matching are disclosed. Liquidity Matching is the funding of debits through the controlled consolidation of liquidity from one or more prioritized stores of funds or value at the point of need. Debits from an account with insufficient liquidity are rejected or held until sufficient liquidity is available (i.e., via a deposit/credit/receipt or an approved extension of a bank credit line).

Large and multinational clients often have complex legal structures comprising of many layers of legal entities, sometimes internationally domiciled, and with each having multiple bank accounts that may establish banking relationships with multiple bank branches around the world.

Clients may hold accounts with cash deposits, denominated in many global currencies or other liquid asset classes (e.g., precious metals, cryptocurrencies, loyalty points, etc.). Clients may decide to fund their payment activities by exchanging cash between currencies or liquidating assets to cash.

Liquidity is often dispersed across multiple accounts of varying types (currencies, asset classes, etc.) that are associated with multiple bank branches and owned by multiple legal entities. No individual account may have sufficient liquidity to fund a debit.

A client may decide to fund an important debit by consolidating liquidity across an account structure (e.g., account to account money movements, potentially enabled by foreign exchange or liquidating assets).

Clients with complex legal entity and account structures may need to define a preferential hierarchy of liquidity sources and establish limits that control how liquidity moves across their account structure to comply with regulations and maintain a stable balance sheet.

A liquidity match identifies funding sources for one or more prioritized debits, at the time of funding, in a way that honors any liquidity funding priorities and net notional borrowing and lending limits between account or other sources of funds (e.g., credit lines/facilities).

Embodiments may automatically match funding requests with the available sources of funds at the time of funds control. This may bring benefits to the client and efficiency to the wider financial system and the bank, which is potentially able to reduce its operational costs by reducing the amount of funds it needs to have readily available for lending.

In embodiments, banks and/or clients may require that controls or limits be placed around the amount of funds that can be notionally borrowed or lent. These limits may apply between accounts, between groups of accounts, between client legal entities, between credit lines/facilities and accounts and between bank branches. The limits help mitigate against various forms of risk, e.g., counterparty credit risk and in some cases these limits are mandated by regulators.

In embodiments, various sources of funds may be used as sources of liquidity for funding debits. These may include simple cash accounts in a single currency, collections of cash accounts held in multiple currencies and accounts which hold other assets (e.g., precious metals and loyalty points). A live representative “market value” may be required to assess the equivalent values in a single/common unit of currency (e.g., foreign exchange rates, derived from foreign exchange markets, or the monetary value of precious metals, derived from metal exchange markets). Both the bank and clients may have a view as to the priority, or sequence, for drawing funds and the priority in which payments are funded.

Intelligent liquidity matching is the process of funding a prioritized set of debits across an available liquidity structure (as agreed between the bank and its clients) through the controlled notional consolidation of liquidity from one or more prioritized stores of funds or value at the point of need. Intelligent liquidity matching is complicated to model and implement at speed and scale, since as the number of accounts or funding constraints in a liquidity structure increases, or the number of debits to be matched grows, an increasing number of constraints need to be evaluated and updated simultaneously in a synchronized blocking operation. This potentially limits the throughput of the funds control process, particularly when the liquidity updates need to be replicated to geographically distant regions, where the speed of light will introduce unavoidable latency.

In one embodiment, intelligent liquidity matching may be modeled as a mathematical combinatorial optimization problem. Funding or lending relationships between sources of funds and the debits to be funded may be modelled as nodes on a graph, with the edges representing the direction in which funds can notionally move between the accounts/credit lines/legal entities. The values on the edges may represent constraints on how much money/value can flow across the edge (thereby applying limits or controls on notional borrowing or lending between accounts or groups of accounts) and the notional cost of moving the money.

In this approach, the notional cost is used to represent the inverse priority of using the source of funds or funding the debit (e.g., fund sources or debits with lower cost values are prioritized for funds drawdown/funding first). The cost may be influenced by any actual/perceived financial costs or risks, e.g., to avoid drawing down credit lines/facilities/loans which may incur a charge for use, however for the purposes of liquidity matching the cost does not necessarily need to represent or involve any direct monetary charge. Where there are no constraints on the re-distribution of funds, the constraint can be represented as infinity (or a sufficiently large number that the constraint is never practically reached).

The debits to fund and the net money movements of available funds from across the structure which fully or partially fund the debits may be determined using a maximum flow with minimum cost algorithm. Example algorithms which solve the general problem of maximum flow in a graph include Ford-Fulkerson, Edmonds-Karp and Push Relabel. These algorithms are subsequently generalized to incorporate the minimum cost optimization on top of the maximum flow. For example, a cost-scaling variant of the Push-Relabel algorithm may generate a solution that achieves the maximum flow (in this case, the maximum amount of liquidity that can be used for debit funding, given all the constraints) in a way which minimizes the costs (in this case, prioritizing the source of funds and the debits to be fund). Thus, the algorithm “optimizes” the liquidity matching for a given set of debits and sources of available funds/balances.

The output of these algorithms may include a set of “augmented paths” with flows which can be interpreted to understand the net movement of funds across the structure and in turn the account balance changes, the proportion of each individual debit that can be funded, the net notional borrowing/lending position (and amount) for each account and the net change to any notional borrowing/lending constraints.

The algorithm may be embedded into a cyclical process applied during funds control, which takes as inputs the list of debits to fund, the available balances for the funds sources, lending relationships, and current net constraints on lending between accounts/credit lines/legal entities and any market value information. In embodiments, all values may be required to be represented in the same currency.

In addition, a list of credits to apply to the structure may be supplied. Thus, account balances may be “topped up” with new available funds.

The value of pre-approved debit notifications, cancelled credits (“receipts”) or legal holds may be deducted from available balances before executing the algorithm. Any available account balance (or supply) which becomes negative, or “overdrawn”, cannot supply funds to the structure, and embodiments may assume a zero available balance (or supply) on the graph for the purpose of the liquidity.

As notational lending occurs between accounts in the liquidity structure, the constraints on the flow of money between the accounts/nodes may be updated every cycle. If the lending involves a transfer of value across different currencies or sources of value (e.g., precious metals to cash), then the notional lending (and in turn the net constraints) may be periodically updated with the latest market values in order to mitigate any market risk.

When credits (or “receipts”), cancelled debits, cancelled legal holds or uncommitted funds from partially funded debits (processed in a previous cycle) are received, the positive addition of credit funds to the account/balance sharing structure may be applied in a way that attempts to repay notional lending between accounts/client legal entities/credit lines in a prioritized order. For example, the client or the bank may wish to repay the credit lines first because they incur a charge for usage, or to repay notional lending with a market/foreign exchange risk. When asymmetric lending rules between the accounts are also considered, notional lending repayment or rebalancing may be performed using a different graph structure, where the nodes may represent the amount of notional lending that needs to be repaid and the accounts or funding sources that may be used to repay the notional lending. The edges indicate permissible notional transfer of funds to repay any notional lending (e.g., from accounts or credit facilities). The constraints may represent any limits on how much each funding source can supply to repay the notional lending and the notional “costs” indicate the relative priority of repaying multiple notional lending amounts and the usage of funding sources for repayments. A lower “cost” figure indicates a higher priority for repayment of a specific notional lending amount or usage of the funding source's available funds for the repayment.

In this approach, the notional “cost” is used to represent the inverse priority of using the source of funds or repaying the notional lending (e.g., fund sources or notional lending with lower cost values are prioritized for funds drawdown/repayment first). The cost may be influenced by any actual/perceived financial costs or risks, e.g., to avoid drawing down credit lines/loans which may incur a charge for use, however for the purposes of notional rebalancing the cost does not necessarily need to represent or involve any direct monetary charge. Where there are no constraints on the re-distribution of funds, the constraint can be represented as infinity (or a sufficiently large number that the constraint is never practically reached).

The notional lending to repay and the net money movements of available funds from across the structure which fully or partially repay the notional lending amounts may be determined using a maximum flow with minimum cost algorithm. Example algorithms which solve the general problem of maximum flow in a graph include Ford-Fulkerson, Edmonds-Karp and Push Relabel. These algorithms are subsequently generalized to incorporate the minimum cost optimization on top of the maximum flow. For example, a cost-scaling variant of the Push-Relabel algorithm may generate a solution that achieves the maximum flow (in this case, the maximum amount of liquidity that can be found, given all the constraints) in a way which minimizes the costs (in this case, prioritizing the source of funds and the notional lending to be repaid). Thus, the algorithm “optimizes” the notional lending rebalancing or repayment for a given set of notional lending amounts and sources of available funds/balances.

When combined with the liquidity matching routine in the same cycle, it usually makes sense to directly apply the credits, any pre-approved notified debits, any new/cancelled legal holds and any cancelled debits/credits to the respective available account balances; then settle the notional lending, before funding debits. However, the execution order may be varied to achieve different outcomes for the client and bank.

The output of these algorithms may include a set of “augmented paths” with flows which can be interpreted to understand the net movement of funds across the structure and in turn the account balance changes, the proportion of each individual notional lending that can be repaid, the net notional borrowing/lending position (and amount) for each account and the net change to any notional borrowing/lending constraints.

In embodiments, alternative generalized constraint optimization, or constraint programming, algorithms may alternatively be used to find similar solutions to the same mathematical combinatorial optimization problems of debit funding and notional rebalancing as the maximum flow with minimum cost algorithm, either as separate or a single combined algorithm execution. Constraint programming solvers may focus on finding a feasible solution, rather than finding an optimal solution and may be implemented using as a specialized computer language and/or a packaged computer code library. Moreover, a minimum cost flow may be represented as a mathematical assignment problem, enabling more specialized linear assignment solvers to be used by embodiments which may offer faster solution times and improved performance compared to more generalized constraint optimization and constraint programming alternatives.

In other embodiments, a specialized alternative algorithm may be used to solve the specific set of debit funding and notional rebalancing mathematical combinatorial optimization problems that are applicable to certain funds control system(s) according to specific business rules. Specialized alternative algorithms may solve the combined problems of debit funding and notional rebalancing in one or more steps and offer improved performance over the more generalized maximum flow with minimum cost algorithms. Specialized alternative algorithms and may be implemented using classical and bespoke computer hardware, for example suitably configured field-programmable gate arrays or quantum computers/processors which may be integrated with a computer.

The output of the cycle may include account and credit line metadata (account numbers, branch identifier, etc.), the account balances (before and after), the available account balances (“supply”, before and after), the full and remaining credit line amounts, the net flow of funds between accounts and/or credit lines in the balance sharing group structure, the remaining net notional borrowing/lending constraints between the sources of funds, a list of credits applied, a list cancelled debits/credits, a list of new/cancelled legal holds and a list of debits fully or partially funded (and the amount of funding). This may also include debits that were not funded or rejected for some other reason (e.g., account blocked) and any FX/market rates used for the conversion of values to a single currency. This output can be integrity protected and encrypted for privacy using cryptographic techniques and linked to a previous cycle run using a unique identifier, effectively creating an integrity protected “blockchain” that can be used for audit and to verify that there are no missing or corrupted data.

The cycle output data may be distributed via the availability liquidity API to clients via APIs, websites, user interfaces and also used by bank operations teams to interpret and understand funds control decisions. Variations of the algorithm may be re-run automatically or on-demand using the available account balances and any partially funded debits, to notionally rebalance funds from the partially funded debits in order to establish the actual available account balances and credit line usage.

A maximum flow algorithm, such as Ford-Fulkerson, Edmonds-Karp and Push Relabel, could be executed using the mathematical debit funding graph with the available account balances, remaining credit line amounts and the remaining notional borrowing/lending limits in order to determine the maximum debit funding amount for any account in the structure (or the structure overall), based on the liquidity position of the structure.

In embodiments, a client's accounts may be spread among different banks. To facilitate balance tracking, and money movements, a distributed ledger or blockchain-based network may be used.

The disclosures of U.S. Pat. Nos. 11,410,166, 11,544,788, U.S. Patent Application Publication No. 2021/0110381, U.S. Patent Application Publication No. 2021/0209585, and U.S. Patent Application Publication No. 2021/0224794 are hereby incorporated, by reference in their entireties.

The problem of matching liquidity from multiple sources, subject to the constraints of funds availability, permitted notional borrowing/lending, asymmetric priorities and notional borrowing/lending constraints, can be modelled as a mathematical graph and efficiently and rapidly solved to identify fundable debits using a maximum flow with minimum cost algorithm.

A maximum flow with minimum cost algorithm powered funds control can host the algorithm in a continuous micro-batching liquidity matching computer program, which is able to simultaneously evaluate many thousands of debit funding requests, credits, pre-approved debits, new/cancelled legal holds and cancelled debits/credits in a single micro-batch cycle in milliseconds (versus naïve sequential evaluation of the individual requests against the constraints and position). Micro-batching is a cyclical process that runs sequentially and continuously many times per second. For example, the process may run tens of times per second. Other frequencies may be used depending on the performance of the computer hardware, the desired funds control response latency and the desired batch time window over which to simultaneously consider and evaluate funds control requests.

The client's holistic liquidity position and money movement activity (debits/credits/etc. requests and responses) can be captured repeatedly as complete binary snapshots, which can be linked together using unique references, digitally signed and encrypted for data integrity, authenticity and privacy protection.

A micro-batching approach reduces the load and contention on database/data storage technologies by handling many thousands of requests in a single database operation, enabling efficient synchronized persistence over multiple physically separated sites for multi-region resiliency. It would be impossible to achieve the same request throughput and geographic resiliency for a given balance sharing group by handling requests sequentially, as each request may incur many milliseconds of latency due to the speed of light impacting the round-trip network latency for the multi-region synchronized liquidity snapshot persistence operation.

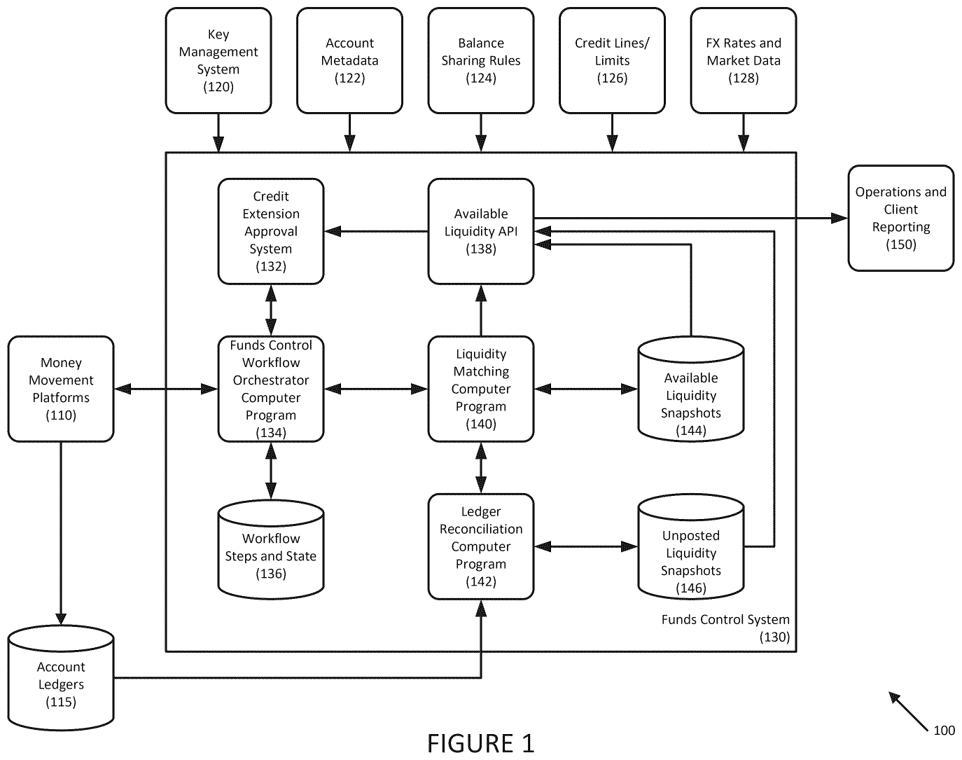

FIG. 1 depicts a high-level system diagram according to embodiments. System 100 may include money movement platforms 110, account ledgers 115, key management system 120, account metadata store 122, balance sharing rules store 124, credit lines/limits store 126, foreign exchange (FX) rates and market data 128, funds control system 130, and operations and client reporting 150.

Money movement platform 110 may include systems that orchestrate financial transactions requiring client cash. Examples of such systems may include systems that process high-value wire payments for a client, systems that specialize in processing instant (or “real-time”) payments, systems that purchase foreign currency or other investments (stocks, bonds, financial options, etc.), etc.

Account ledgers 115 may maintain account information, including balances, transactions, etc. Account ledgers 115 may also maintain a record of account information, such as financial holds placed by money movement platform 110 on the account (e.g., to ringfence funds, perhaps due to a legal requirement), account alerts and blocks (e.g., to prevent certain account activity, such as debits), etc. Account ledgers 115 may also be used to calculate and apply interest and borrowing charges.

Key management system 120 may be a hardware security module or other secure key storage and may provide secure generation, rotation, distribution and storage of symmetric and asymmetric encryption and digital signature keys and key pairs.

Account metadata store 122 may provide account information, status, and any other metadata, possibly sourced from account ledgers 115. Account metadata store 122 may be used as part of the request from money movement platforms 110 for validation checks, such as whether the account exists, whether there are any blocks/restrictions on the account, etc. Funds control workflow orchestrator computer program 134 may check account metadata store 122 before processing the request or replying to money movement platforms 110.

In one embodiment, funds control workflow orchestrator computer program 134 may have a local and periodically updated cache of the account metadata held by account metadata store 122 to improve performance and reduce latency.

Balance sharing rules store 124 may provide rules on notional balance sharing (e.g., account groupings, priorities and limits for notional balance lending and borrowing, etc.).

Credit lines/limits store 126 may provide credit lines and amounts/limits (e.g., maximum value of funds that the bank is willing to lend the client on an intraday/overnight basis).

Foreign exchange (FX) rates and market data 128 include intraday rates and values, enabling funds control to calculate an equivalent value for notional balance sharing across accounts denominated in multiple currencies or asset classes (e.g., FX rates and markets prices for securities, commodities, bonds, investments, etc.).

Funds control system 130 may include credit extension approval system 132, funds control workflow orchestrator computer program 134, workflow step and state store 136, availability liquidity application programming interface (API) 138, liquidity matching computer program 140, ledger reconciliation computer program 142, available liquidity snapshot store 144, and unposted liquidity snapshot store 146.

Credit extension approval system 132 may handle requests to extend approved credit lines and limits for in-flight funds control requests. The requests may originate from funds control workflow orchestrator computer program 134 depending on the workflow steps defined in workflow step and state store 136 for the request type and originating money movement platform 110.

Funds control workflow orchestrator computer program 134 may retrieve a workflow from workflow step and state store 136 in response to a request from money movement platform 110. The workflow may be based on the request type, the amount, the requesting system, the account, etc.

The request from money movement platforms may be to obtain authorization that there are sufficient funds available for the proposed cash demand, or to notify funds control workflow orchestrator computer program 134 of a receipt activity, or a pre-approved debit activity. For example, a bank may decide that certain money movement platforms 110 do not need to check the client's liquidity and instead only need to relay their cash movement activities to funds control workflow orchestrator computer program 134 to ensure that the funds control balance is accurate and inclusive of all activity.

Funds control workflow orchestrator computer program 134 may keep track of requests from money movement platform 110 as the funds control request state changes (e.g., received from money movement platforms 110, sent to liquidity matching computer program 140, received answer from liquidity matching computer program 140, sent to credit extension approval system 132, received answer from credit extension approval system 132, sent to liquidity matching computer program 140, received answer from liquidity matching computer program 140, and replied to money movement platforms 110.

Liquidity matching computer program 140 may process the tracking and assessment of available funds.

Ledger reconciliation computer program 142 may keep track of funds control and ledger activity and may maintain synchronization of the liquidity matching computer program balances with completed ledger activity.

Available liquidity snapshot store 144 may store snapshots of available liquidity for one or more accounts and credit lines. Examples of information that may be included in each liquidity snapshot include the prior and new account balances, the prior and new account available balances (which take into account any notional borrowing or lending), credit lines/facilities (e.g., maximum and remaining/available amount), details of any credits/receipts applied (e.g., amount, reference number, etc.), details of any notified debits applied (e.g., amount, reference number, etc.), details of any debit funding requests (e.g., amount asked for, amount funded, reference number, priority, etc.), details of any cancelled debits/credits (e.g., amount, reference number, etc.), details of any new/cancelled legal holds (e.g., amount, reference number, etc.), the amount of any notional lending/borrowing by account, potentially including FX rates if the notional borrowing/lending is multi-currency (e.g., between two accounts held in different currencies), a description of the graph which captures the balance sharing rules (i.e., nodes, edges, etc.), priorities on the use of the funding sources for balance sharing, overall and remaining limits on notional balance sharing between accounts or an account and other accounts in a group of accounts in a balance sharing node/group, FX rates to convert available balances, etc. into a single base currency for notional balance sharing, account and credit line metadata (account number, branch, credit line reference number, etc.), reference to the previous liquidity snapshot, a date/time stamp, references to the computer system/micro-batching computer program which processed the request, any version numbers used to version control the schema, any signatures for integrity and authenticity protection (optional if an encrypted cypher like Advanced Encryption Standard (AES)-Galois/Counter Mode (GCM) is used to encrypt and add authenticity and integrity protection), etc.

A snapshot may include all this information for a single standalone account (no notional lending/borrowing permitted), a graph of accounts (set of accounts which can notionally borrow/lend), or all the accounts for a client.

Unposted liquidity snapshot store 146 may store references to funded but unposted (e.g., the money movement has not yet completed/settled and therefore has not yet been notified to the account ledger(s)) debit money movements/transactions, notified credits/pre-approved debits, etc. Unposted liquidity snapshot store 146 may store references back to liquidity snapshot version numbers to stay in sync with available liquidity snapshot store 144.

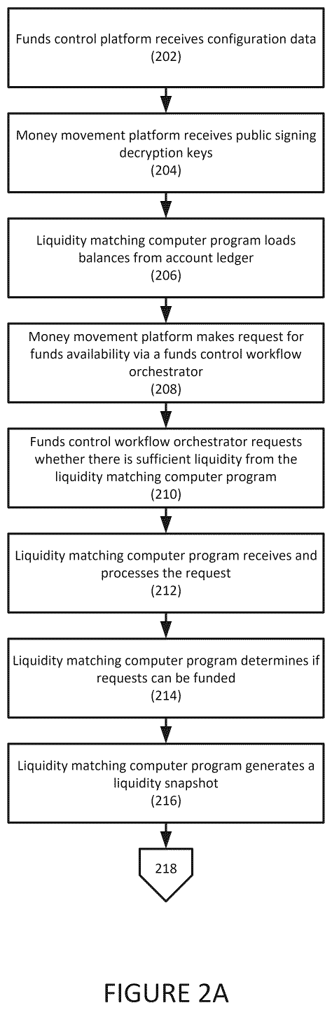

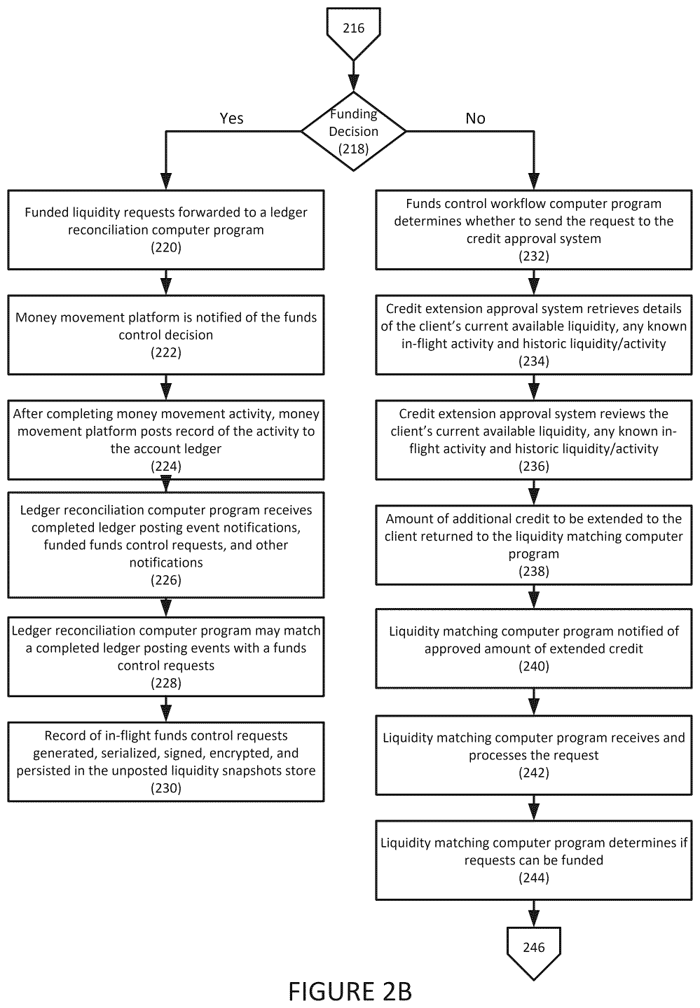

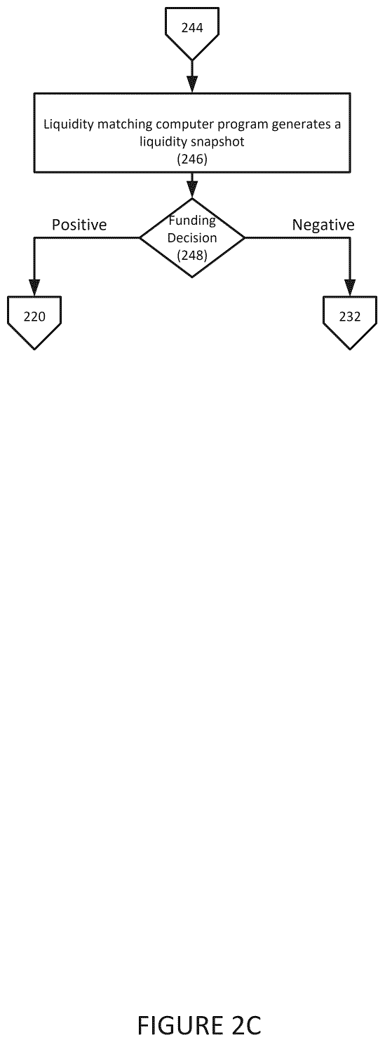

FIGS. 2A-2C illustrate a method for funds control according to an embodiment.

In step 202, a funds control system may receive configuration data. This may include, for example, encryption and digital signature keys (e.g., keys used by the moment movement platforms to sign their requests to funds control and/or keys used by funds control to sign the responses to funds control requests), account information, status, and any other metadata, rules on notional balance sharing (e.g., account groupings, priorities and limits for sharing, etc.), credit lines and amounts/limits (e.g., funds which the bank is willing to lend the client on an intraday/overnight basis), intraday rates and values, etc.

A funds control workflow orchestrator computer program may also load workflow steps from a workflow state and step store.

In step 204, a money movement platform may receive public signing and decryption keys, enabling validation of funds. The keys may be used to control funds control request/response integrity and authenticity. For example, the money movement platform may sign requests to a funds control orchestrator (to prove origin and integrity) using a key management system and hardware security module (or alternative key storage).

The money movement platform may also validate the integrity and authenticity of the responses received from funds control.

In step 206, the liquidity matching computer program may load the latest liquidity snapshots for the accounts/balance sharing groups from an available liquidity snapshot store, and a ledger reconciliation computer program may load the latest unposted ledger reconciliation snapshots from an unposted liquidity snapshot store.

In one embodiment, the funds control system may be initially synchronized with the balances held in the account ledger(s) at a well-defined point in time (e.g., at the start or end of the branch or account business day) when there may typically be a short pause in the ledger processing. For example, the ledger may produce a file/report/API with a snapshot of all the available account balances to be loaded into the liquidity matching computer program. Credit lines/limits and FX rates and market data may also be sourced in order to gather a complete view of the client's liquidity in a common currency.

Negative or overdrawn ledger balances are considered to be notionally borrowing funds of an amount equal to the absolute negative balance value. Accounts with a positive ledger balance may be notionally lending available funds to other accounts in the same balance sharing group, or funds may be notionally lent by the credit line(s), depending on the balance sharing rules for notional borrowing/lending between accounts and any notional borrowing/lending limits.

The available balances (supplies) of the accounts, credit line usage, remaining credit line amounts, notional borrowing/lending amounts and the remaining notional borrowing/lending limits for use in liquidity matching can be calculated using an amended version of the notional rebalancing method which uses the balances from account ledgers 115, balance sharing rule store 124, credit lines/limits store 126, FX rates and market data 128 as inputs.

During the initial ledger account balance synchronization, money movements will be held by the money movement platforms waiting on the availability of the funds control system. Any money movements that were in-flight and not included in the ledger account balance snapshot may be incorporated into the funds control balances by the ledger reconciliation computer program, via notifications to the liquidity matching computer program, after the initial synchronization has completed.

Subsequent starts of the liquidity matching computer program may retrieve the latest available balances from the available liquidity snapshot store.

If the ledger sends a new/updated ledger balance with the posting, then the ledger reconciliation computer program can take the account balance maintained by the liquidity matching engine, deduct any known in-flight activity and then compute the expected ledger balance. This can in turn be used to continuously adjust the liquidity matching computer program balance to help keep it synchronized.

In step 208, the money movement platform may make a funds control request made to a funds control workflow orchestrator computer program. The request may be for funds that are required immediately or within a certain time period; or a notification of actual or known future money movement (e.g., actual or advised receipt of funds); or a notification of a pre-approved debit; or a request to ring-fence/hold funds; or a modification/cancellation to an earlier request.

In one embodiment, the money movement platform may also send notifications of any receipts/credits to the account, plus any pre-authorized debits. These may flow through the funds control workflow orchestrator computer program to the liquidity matching computer program, where they are captured as part of the liquidity snapshot and stored in the available liquidity snapshot store. Receipts/credits and pre-authorized debits may be handled in a similar way to cancellations as they are applied directly to the account balances, thereby altering the liquidity.

In step 210, the funds control workflow orchestrator computer program may request whether there is sufficient liquidity from the liquidity matching computer program. The request may be a notification of an actual or known future money movement (e.g., the receipt of funds).

In step 212, the liquidity matching computer program may receive and process the request. Duplicate requests, which have previously resulted in a change to an account balance, are identified and rejected. Modification/cancellation requests are checked to ensure the money movement has not already completed (i.e., “posted” to the ledger). Modification/cancellation requests which are found to have already completed may be rejected.

In step 214, the liquidity matching computer program may use a trigger (e.g., a time window or a pending request volume) to apply notifications/holds and evaluate the available liquidity, subject to priorities and limits, to determine if requests for funds can be funded using either cash available in the account (to be debited), or an account which can notionally share balances, or any approved credit line, or an approved credit extension.

In one embodiment, all requests are executed by a method in the liquidity matching engine based on a trigger. The steps in the method which are executed will vary depending on the requests which have been received in the request buffer of the liquidity matching engine in-between executions of the micro-batched method. For example, if only receipts/credits have been received, then there are no debits to match/fund.

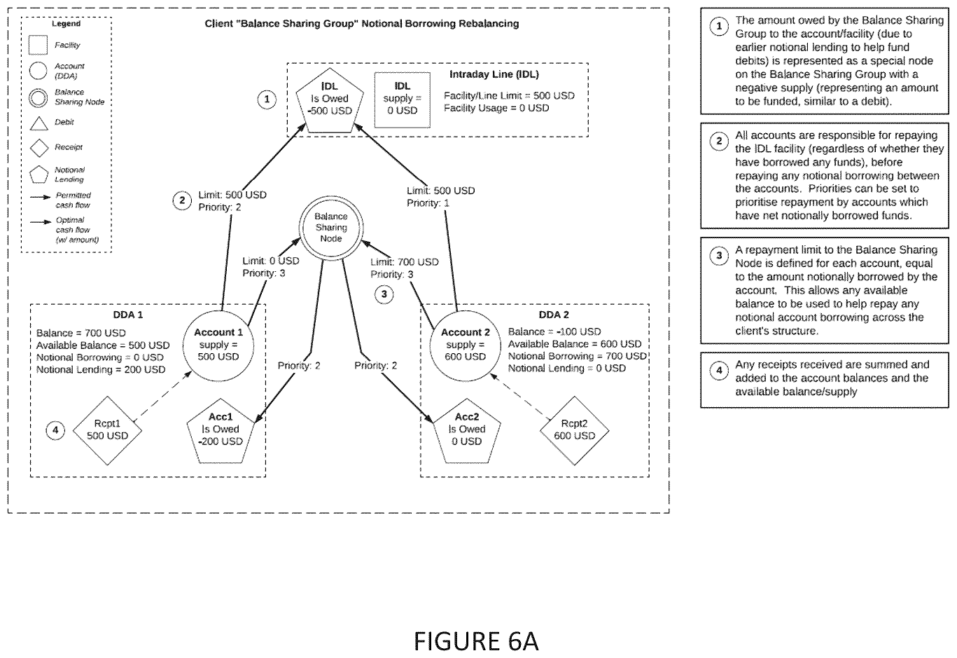

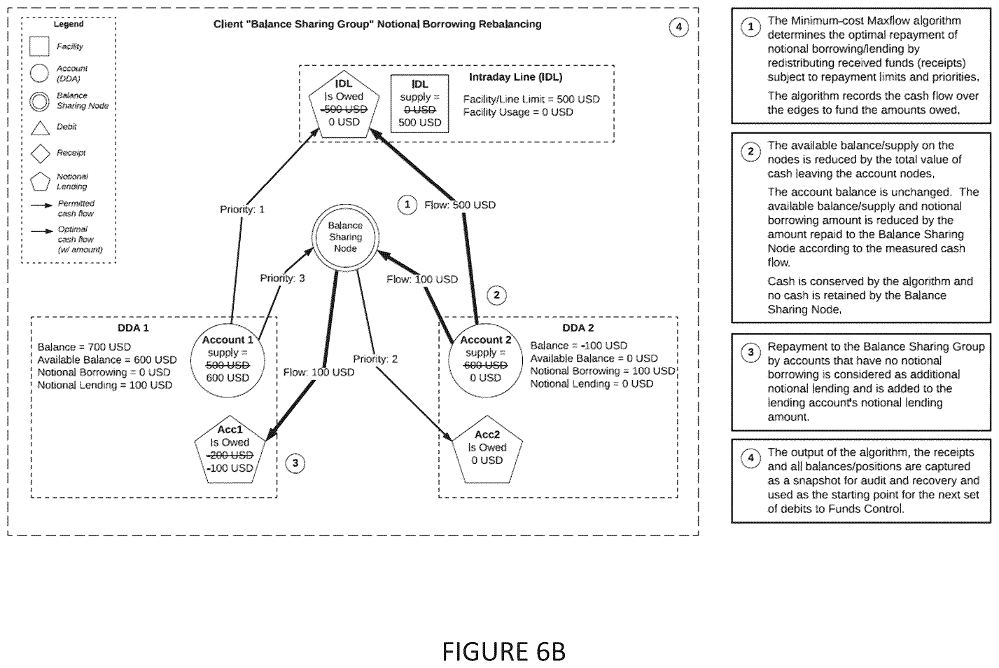

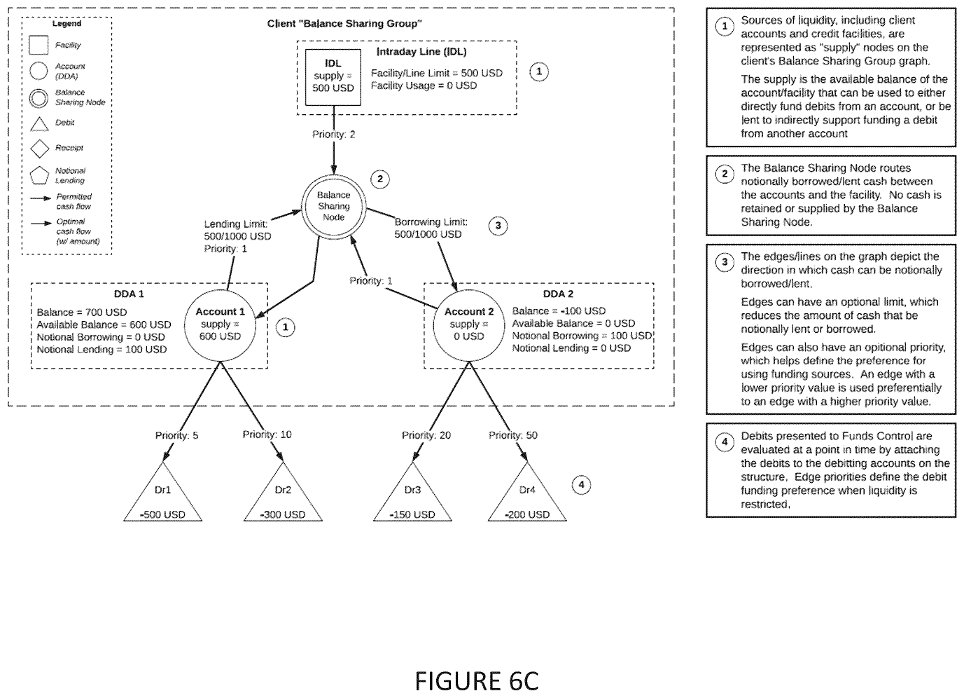

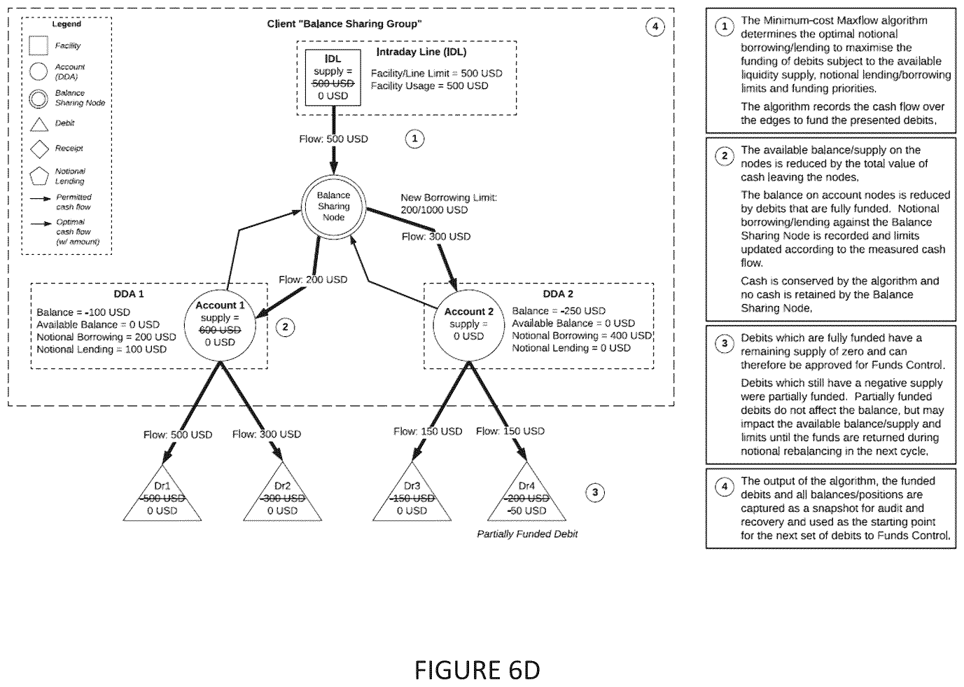

A non-limiting illustration of step 214 is provided in FIGS. 6A-6D.

In step 216, the liquidity matching computer program may generate a liquidity snapshot. Examples of information that may be included in each liquidity snapshot include the prior and new account balances, the prior and new account available balances (which take into account any notional borrowing or lending), credit lines/facilities (e.g., maximum and remaining/available amount), details of any credits/receipts applied (e.g., amount, reference number, etc.), details of any notified debits applied (e.g., amount, reference number, etc.), details of any debit funding requests (e.g., amount asked for, amount funded, reference number, priority, etc.), details of any cancelled debits/credits (e.g., amount, reference number, etc.), details of any new/cancelled legal holds (e.g., amount, reference number, etc.), the amount of any notional lending/borrowing by account, potentially including FX rates if the notional borrowing/lending is multi-currency (e.g., between two accounts held in different currencies), a description of the graph which captures the balance sharing rules (i.e., nodes, edges, etc.), priorities on the use of the funding sources for balance sharing, overall and remaining limits on notional balance sharing between accounts or an account and other accounts in a group of accounts in a balance sharing node/group, FX rates to convert account available balances, etc. into a single base currency for notional balance sharing, account and credit line metadata (account number, branch, credit line reference number, etc.), reference to the previous liquidity snapshot, a date/time stamp, references to the computer system/micro-batching computer program which processed the request, any version numbers used to version control the schema, any signatures for integrity and authenticity protection (optional if an encrypted cypher like AES-GCM is used to encrypt and add authenticity and integrity protection), etc.

The liquidity snapshot may be serialized, signed, encrypted, and persisted in, for example, an available liquidity snapshots store, creating an audit and point of recovery.

Responses to the request from the money movement platform may not be generated until a satisfactory resiliency point has been achieved (e.g., synchronous multi-region replication of state).

In step 218, the funding decision may include acknowledgement of fully funded debits; receipts/credits applied; any pre-approved notified debits applied; any new or cancelled legal holds applied; any cancelled debits or credits applied; any processing errors; or a negative funding decision for a debit that could not be fully funded.

If, in step 218, the funding decision is positive, in step 220, a copy of the funded liquidity requests and any applied receipts/credits and any pre-approved debit notifications may be forwarded to a ledger reconciliation computer program, so that it can begin tracking the completion of transactions, and a copy of all activity and the liquidity snapshot may be sent to the available liquidity API for retrieval by or broadcast to the credit extension approval system, clients, bank operations and reporting.

In step 222, the funds control workflow orchestrator computer program may notify the money movement platform of the funds control decision (“yes” there are sufficient funds) and the workflow state is updated.

In step 224, the money movement platform may continue its workflow, which may involve other checks (e.g., sanctions, fraud, etc.) or interactions with external clearing systems, and after completing the money movement activity, the money movement platform may post a record of the settled activity to the account ledger, which captures a record of the client's account activity.

If the money movement platform decides to cancel the transaction, then a reversal would come back in at step 208 and follow the same flow to reverse the effect on the available balance. Steps 226, 228 and 230 would not be processed in this case.

In parallel, in step 226, the ledger reconciliation computer program may receive completed ledger posting event notifications, funded funds control requests, and other fund control notifications (e.g., receipts).

In one embodiment, a ledger reconciliation computer program may re-load its state from an unposted liquidity snapshot store and catch-up on any missed account ledger activity. In one embodiment, this may require the account ledger to maintain and publish a monotonically increasing sequence number/Lamport clock/etc. The sequence may be captured in the reconciliation state object stored in the unposted liquidity snapshots store.

In step 228, the ledger reconciliation computer program may match a completed ledger posting events with a funds control requests (e.g., based on a reference, a set of attributes or a fingerprint/hash) and ensure there is an explainable and expected difference between the ledger balance and that maintained by funds control for an account.

In one embodiment, a micro-batching process that handles many funds control and ledger activity events simultaneously may be used, as it provides benefits of increased speed, scalability, throughput and minimizes database writes and latency incurred by the synchronizing data across multiple geographic regions.

Ledger postings that cannot be reconciled to prior funds control activity may result in a corrective balance notification to the liquidity matching computer program, resulting in a change in the available liquidity for an account/balance sharing group. In one embodiment, the ledger reconciliation computer program may update the liquidity matching computer program with the balance change so that the liquidity matching computer program's balance reflects all completed account activity at the account ledger. The ledger reconciliation computer program may initiate a balance update notification, which may return to step 212 and result in a positive funding decision. Then, the process may return to steps 220, 226, 228 and 230, which may ensure that the account ledger activity has been balanced by an equal change to the balance held by the liquidity matching computer program and the available liquidity snapshot store.

The notification from the ledger reconciliation computer program to the liquidity matching engine may either be a receipt/credit or a pre-approved/notified debit as the cash movement has happened so rules around funding no longer apply: the available balances need to be updated to reflect the cash movements which have been recorded by the ledger. The notification may be received by an API.

In step 230, a record of in-flight (i.e., funded but unposted funds control requests, such as cash movements that have not been sent to/incorporated in the ledger) may be generated, serialized, signed, encrypted, and persisted in the unposted liquidity snapshots store, creating an audit of ledger events and a point of recovery.

If the funding decision in step 218 is negative, in step 232, the funds control workflow orchestrator computer program may determine whether to send the request to the credit extension approval system. If it decides not to, then the remaining flow would be skipped on this branch and a negative decision would be returned to the money movement platforms, ending the process.

In step 234, the credit extension approval system may retrieve details of the client's current available liquidity, any known in-flight activity and historic liquidity/activity, from the liquidity matching computer program using the availability liquidity API.

In step 236, the credit extension approval system may review the client's current available liquidity, any known in-flight activity and historic liquidity/activity. The review may be automated (e.g., based on certain rules, considering the risk profile of the client and/or a prediction of receiving funds); or manual, involving review and approval by credit officer(s) via a user interface/mobile app/API/etc.

If the credit extension approval system decides not to extend credit, then the negative decision is processed by the funds control workflow orchestrator computer program, and the process may be terminated.

In step 238, the value of additional credit to be extended to the client (potentially relating to one or more funds control debit requests) is returned to the funds control workflow orchestrator computer program.

In step 240, the liquidity matching computer program may be notified of an approved amount of extended credit, potentially enabling the funded release of a debit funds control request held at the liquidity matching computer program due to insufficient available funds. For example, if the request has been approved by the credit extension approval system, the credit extension approval system may notify the funds control workflow orchestrator computer program of the value of the approved additional funds, which may notify the liquidity matching computer program.

In step 242, the additional funds may be represented as an extra node on the graph (i.e., an extra of source of funds that can be connected to the applicable debit nodes by additional edges which have a higher algorithm “cost” to indicate a lower priority for usage of the funds (thereby prioritizing usage of the client's available funds, or any existing established credit lines to fund the debits)).

In step 244, the liquidity matching computer program may determine if the debit requests can be funded. The balance sharing rules on this extra source of funds mean that it can only be used to support a specific debit request (or set of debit requests), such as by transaction reference number. If the overall liquidity has not diminished after the credit extension approval system made its decision (e.g., another higher priority debit has not taken the funds) then there should be sufficient funds and the liquidity matching computer program will respond with a positive decision after executing the liquidity matching algorithm. The extra funds are captured as notional lending to be repaid according to prioritization rules as future credits/receipts are received.

The liquidity matching computer program may receive and process the request. Duplicate requests, which have previously resulted in a change to the available liquidity, are identified and rejected. Modification/cancellation requests are checked to ensure the money movement has not already completed (i.e., “posted” to the ledger). Modification/cancellation requests which are found to have already completed may be rejected.

A non-limiting illustration of step 244 is provided in FIGS. 6A-6D.

In step 246, the liquidity matching computer program may generate a liquidity snapshot. Examples of information that may be included in each liquidity snapshot include the prior and new account balances, the prior and new account available balances (which take into account any notional borrowing or lending), credit lines/facilities (e.g., maximum and remaining/available amount), details of any credits/receipts applied (e.g., amount, reference number, etc.), details of any notified debits applied (e.g., amount, reference number, etc.), details of any debit funding requests (e.g., amount asked for, amount funded, reference number, priority, etc.), details of any cancelled debits/credits (e.g., amount, reference number, etc.), details of any new/cancelled legal holds (e.g., amount, reference number, etc.), the amount of any notional lending/borrowing by account, potentially including FX rates if the notional borrowing/lending is multi-currency (e.g., between two accounts held in different currencies), a description of the graph which captures the balance sharing rules (i.e., nodes, edges, etc.), priorities on the use of the funding sources for balance sharing, overall and remaining limits on notional sharing between accounts or an account and other accounts in a group of accounts in a balance sharing node/group, FX rates to convert available balances, etc. into a single base currency for notional balance sharing, account and credit line metadata (account number, branch, credit line reference number, etc.), reference to the previous liquidity snapshot, a date/time stamp, references to the computer system/micro-batching computer program which processed the request, any version numbers used to version control the schema, any signatures for integrity and authenticity protection (optional if an encrypted cypher like AES-GCM is used to encrypt and add authenticity and integrity protection), etc.

The liquidity snapshot may be serialized, signed, encrypted, and persisted in, for example, an available liquidity snapshots store, creating an audit and point of recovery. The data may be stored as a liquidity snapshot in an available liquidity snapshot store. This data may be signed and encrypted for privacy and integrity and authenticity protection.

If, in step 248, the funding decision is positive, the process may continue with step 220.

If, in step 248, the funding decision is negative, the process may abort (thereby ending the process), or the process may return to step 232. The funds control workflow orchestrator computer program may return a negative (“no”) decision to the money movement platforms before stopping processing.

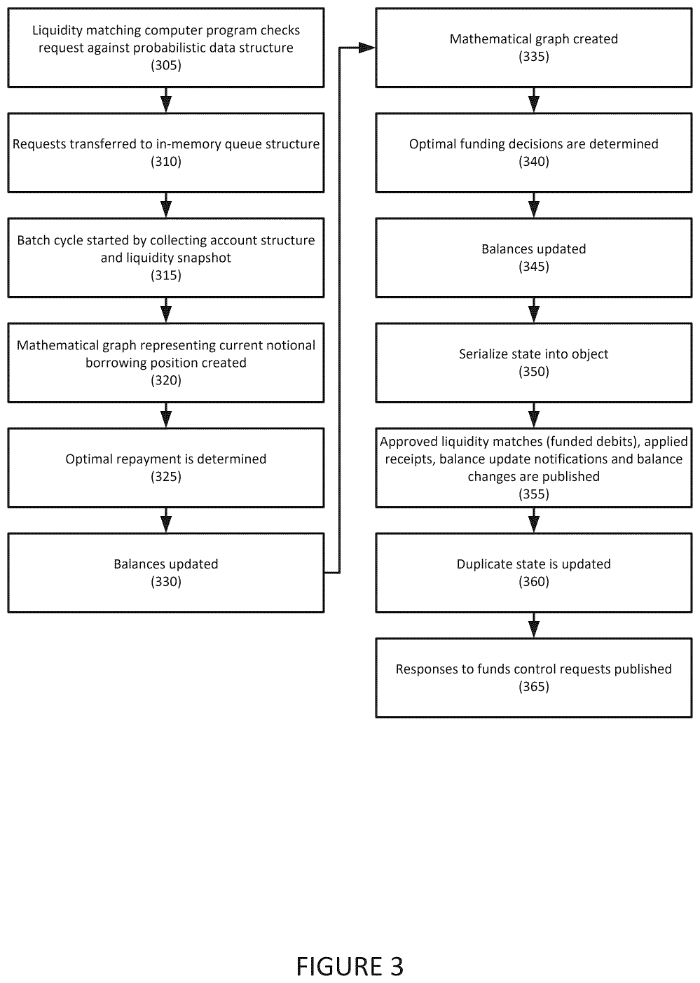

Referring to FIG. 3, additional details on steps 214 and 244 are provided according to an embodiment. Step 244 is similar to step 214, but is executed in response to credit extension approval system being involved (i.e., there are insufficient funds to fund a debit request, and the approval workflow decides to extend additional funds from the bank to enable the debit to be funded).

For example, in step 305, funds control requests received into the liquidity matching computer program are immediately checked against a probabilistic data structure (e.g., a Bloom Filter) to determine if it is a duplicate request which has previously impacted the account balance. Suspected duplicates are handled outside of the core flow to minimize performance impact and may be rejected if found to be a confirmed duplicate.

In step 310, requests are transferred to an in-memory queue structure for subsequent processing by the (micro-) batch cycle.

In step 315 the batch cycle starts by collecting the latest balance sharing rules, account structure and credit line information for the client's balance sharing group and the liquidity snapshot from previous cycle.

In step 320, a mathematical graph representing the current notional borrowing position, and which reflects any changes in the client's accounts, balance sharing rules and credit line amounts and allowed usage, is constructed. Any receipts and debits received are summed and added (i.e., before the algorithm is executed) to the account balances and the available balances (supplies) of the respective account nodes. The available balance/supply may be in a different common currency to the account balance. Thus, a currency/FX or asset value conversion may be required to convert the value of the receipt (or cancelled debt) into the common currency of the balance sharing group structure.

Notifications of pre-approved debits and cancelled receipts may also be applied before execution of the algorithm to reduce the balances and available balances (supplies) of the respective account nodes by the value of the notified/pre-approved debit. The available balance/supply may be in a different common currency to the account balance. Thus, a currency/FX or asset value conversion may be required to convert the value of the pre-approved debit notification (or cancelled receipt) into the common currency of the balance sharing group structure.

New legal holds may be requested by the money movement platforms and are also subtracted from the applicable available account balances (supplies) with the effect of reducing the available balance (supply) of an account without changing the actual account balance. The available balance/supply may be in a different common currency to the account balance. Thus, a currency/FX conversion may be required to convert the legal hold value into the common currency of the balance sharing group structure.

Money movement platforms may also request the cancellation of existing legal holds (e.g., by legal hold reference). The value of a cancelled legal hold is added to the applicable available account balance (supply) with the effect of increasing (restoring) the available balance (supply) of an account without changing the actual account balance. The available balance/supply may be in a different common currency to the account balance. Thus, a currency/FX conversion may be required to convert the value of the cancelled legal hold into the common currency of the balance sharing group structure.

Any funds allocated to partially funded debit requests in the previously executed batch cycle (which are recorded in the snapshot from the previous cycle) are also added to the available account balances (supplies) with the effect of increasing the available account balance (supplies) without changing the actual account balance.

The amount owed by the balance sharing group to the account/credit line (due to earlier notional lending to help fund debits) is represented as a special node on the notional rebalancing balance sharing group graph with a negative supply (representing the amount to be repaid, similar to a debit).

All accounts may be responsible for repaying credit lines (e.g., an intraday line facility) regardless of whether they have borrowed any funds, before repaying any notional borrowing between the accounts. Priorities can be set to prioritize repayment by accounts which have net notionally borrowed funds. For example, a bank may offer an intraday line of credit that is expected to be repaid intraday (i.e., before the end of the business day). Any credit used by the client intraday might not be charged, provided the client repays any credit used (by applying receipts/credits to their account) before the end of the same day. Any credit used overnight might be subject to a charge, so to avoid fees any client account which benefits from usage of the line/facility should contribute towards repayment of the line/facility, through notional lending of its available balance, irrespective of whether the account has notionally borrowed from the line/facility. This may be represented on the graph by additional repayment edges between the account node(s) (with a positive or zero supply equal to its positive available balance) and the node(s) representing the notional lending of the credit line(s) (with a negative or zero supply equal to the amount lent).

A repayment limit on the edges between the account node(s) and the balance sharing node may be defined for each account, equal to the amount notionally borrowed by the account. This ensures that only available balances on accounts which have notionally borrowed are used to help repay the notional lending from accounts across the client's balance sharing group structure. The limit will be zero to the balance sharing node on the accounts which have no notional borrowing, to prevent these accounts repaying notional lending borrowed by other accounts.

A non-limiting illustration of step 320 is provided in FIG. 6A.

In step 325, a maximum flow with minimum cost algorithm may determine the optimal repayment of notional lending by redistributing received funds (receipts) subject to repayment limits and priorities. The algorithm may record the cash flow over the edges to fund the amounts owed.

A non-limiting illustration of step 325 is provided in FIG. 6B.

In step 330, the account balances may be updated due to applied credits/receipts, pre-approved debits, and cancelled debits/credits; available balances (supplies) may also be updated due to credits/receipts, return of funds from partially funded debits, new/cancelled legal holds, and rebalancing of notional borrowing.

Once executed, the augmented path flows that are output from the algorithm are interpreted in order to calculate the new liquidity position of the client: available account balances and remaining credit line amounts (node supplies) and remaining notional borrowing/lending amounts and limits (edge constraint values). The new values will be used to assess the funding of any debit requests which have been presented for evaluation in the same batch cycle.

The available balance/supply on the nodes may be reduced by the total value of cash leaving the account nodes. The supply may also be increased based on any notional borrowing that is repaid.

Cash is conserved by the algorithm and no cash is retained by the balance sharing node.

The balances are not altered by notional borrowing repayment (rebalancing), but they are altered by the total value of receipts/credits, pre-approved debits, legal holds and cancelled debits/receipts applied to the account in this cycle run. For example, the available balance/supply and notional borrowing amount is reduced by the amount repaid to the balance sharing node according to the measured cash flow.

Repayment to the credit line(s) by accounts that have no notional borrowing is considered as additional notional lending and is added to the lending account's notional lending amount.

In step 335, using the updated position, the computer program may construct a different mathematical graph representing permitted notional liquidity sharing for debit funding. The graph represents the funding sources, plus the allowed notional borrowing/lending between accounts (and any priorities and limits on notional balance lending/borrowing or rules) and the debits to be funded.

New debits from the queue may be represented as nodes on the graph with edges created between the node representing the account from which the debit is being made and the debit node. The edge between the account and debit nodes generally has a limit (or algorithm “constraint”) that is much larger than the value of the debit and a priority (or algorithm “cost”) that indicates the relative priority for funding the debit. This allows the algorithm to prioritize utilizing limited available funds for higher priority (lower algorithm “cost”) debits. The priority can also be set according to other business objectives, for example prioritizing the funding of lower value debits over higher value debits (to mitigate the algorithm partially funding a higher value debit at the expense of theoretically fundable lower value debits), or to prioritize debit requests based on the time when they were presented to funds control (e.g., first to ask, first to fund). Priorities can be dynamically changed during the execution of every batch cycle. Debit nodes have a negative supply value equal to the value of the debit, which may need to be converted into the single common currency used on the graph to represent the value of the liquidity.

Incompletely funded debits which may be allowed a certain time period for liquidity matching and funding to complete, may be re-attached to the graph in a similar way to new debits as nodes with negative supply equal to the value of the debit and an edge between the account and the associated debit nodes. The relative priorities (algorithm “costs”) of the debits may be reassessed to ensure that the correct business rules for debit funding prioritization are being applied in the current batch cycle.

The available balances/supplies of the balance sharing group graph may be in a different common currency to the debit currency. Thus, a currency/FX/asset class conversion may be required to convert the value of the debit into the common currency of the balance sharing group structure.

Sources of liquidity, including client accounts and credit facilities, are represented as supply nodes on the client's balance sharing group graph.

The balance sharing node routes notionally borrowed/lent cash between the accounts and the facility. No cash is retained or supplied by the balance sharing node.

The edges/lines on the graph depict the direction in which cash can be notionally borrowed/lent. Edges may have an optional limit, which reduces the amount of cash that be notionally lent or borrowed. Edges may also have an optional priority (which is represented by an algorithm “cost”), which helps define the preference for using funding sources. An edge with a lower priority value is used preferentially to an edge with a higher priority value.

Debits presented to funds control are evaluated at a point in time by attaching the debits to the debiting accounts on the structure. Edge priorities define the debit funding preference when liquidity is restricted.

A non-limiting illustration of step 335 is provided in FIG. 6C.

In step 340, the algorithm is run to determine which debits can be funded, the optimal solution, the balances/supplies and the notional borrowing/lending funding paths which funded the debits. The computer program may determine optimal funding decisions. The maximum flow with minimum cost algorithm may be executed to establish how the debits should be funded. Once executed, the augmented path flow outputs of the algorithm may be interpreted, and the positions updated with new supplies/available balances and notional borrowing/lending limits. The supply is the available balance of the account/facility that can be used to either directly fund debits from an account or be lent to indirectly support funding a debit from another account.

A non-limiting illustration of step 340 is provided in FIG. 6D.

In step 345, the account balances may be updated due to fully funded debits; available balances/supplies may also be updated due to fully and partially funded debits and notional lending. The algorithm records the optimal cash flow over the edges to fund or partially fund the presented debits. The available balance/supply on the nodes is reduced by the net value of cash leaving the nodes. The balance on account nodes is reduced by debits that are fully funded. Notional borrowing/lending against the balance sharing node is recorded potentially including a FX rate used where the account currency differs to that of the balance sharing group) and limits updated according to the measured cash flow.

Debits which are fully funded have a remaining supply of zero and can therefore be approved for funds control. Fully funded debits are applied to the account balances (which will be denominated in the same currency/asset class), reducing the balance by the value of the debit.

Debits that still have a negative supply were not fully funded and may be referred for manual funds control approval by the credit extension approval system by the funds control workflow orchestrator computer program.

Partially funded debit flows may contribute to the measured cash flows across the graph, reducing available balances (supplies) and may result in notional borrowing, but they are not applied to the account balance. Funds allocated to partially funded debits are returned to the account from which the debit is being made and redistributed to the balance sharing group (as needed) as part of the rebalancing steps 320, 325 and 330 when the next batch cycle is triggered.

In step 350, the state from the batch cycle may be serialized into a binary object for persistence. This object may then be cryptographically signed and encrypted before persistence into the available liquidity snapshots store, which may be a multi-region distributed database that ensures changes are synchronously replicated out-of-region for enhanced recoverability.

The snapshot may be encrypted and/or signed depending on the data sensitivity and cryptographic algorithm used (authenticated cyphers may provide both privacy and integrity and authenticity protection). It may be stored in a database.

The snapshot may be used for audit and recovery and as the starting point for the next set of debits to funds control.

In step 355, approved liquidity matches (funded debits), applied credits/receipts, pre-approved debits, cancelled debits/receipts, new/cancelled legal holds and balance changes may be published to the ledger reconciliation computer program and the available liquidity API. The data may be published as a copy of the liquidity snapshot object created in step 350, thereby potentially maintaining data privacy and allowing recipients to validate the integrity and authenticity of the data received.

In step 360, the duplicate state may be updated with any activity which has impacted the account balances or any applied legal holds prior to replying to the money movement platform and after the database write has been successful.

Prior to the response being sent the probabilistic idempotency filter is updated using a hash of attributes pertaining to the activity (e.g., transaction or hold reference number, money movement platform system identifier, account number, amount, etc.) to indicate that account balance(s) and available balance(s) (supply(ies)) have been updated to incorporate the activity. This may be a funded debit request, a pre-approved notification of a debit or a credit/receipt. Applied legal holds may also be incorporated into the duplicate check. Debit requests which were only partially funded may have altered the available balance(s) captured in the liquidity snapshot for this cycle, but as they do not alter the account balance, they are not added to the probabilistic idempotency filter, allowing these debit requests to be re-sent and processed again in the hope that there may now be sufficient liquidity to fully fund these debits. The updated probability idempotency filter can subsequently be used to detect and de-duplicate future requests that have previously altered the account balance(s).

In step 365, the responses may be published to the funds control requests.

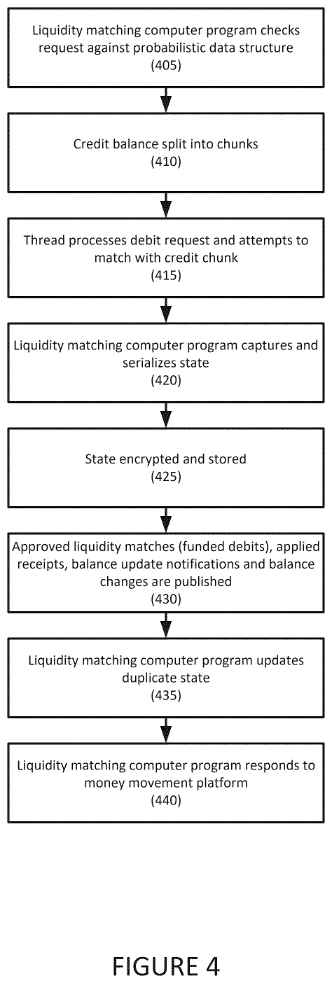

Referring to FIG. 4, a method for liquidity matching is disclosed according to an embodiment.

Alternatively, a liquidity matching market may maintain an order book of debits to be matched with chunks of available credit in memory for a single account: one side of the order book lists credits/receipts applied to the account, while the other side keeps a list of debits (in the currency of the account).

The liquidity matching market may be shared across multiple computer processor threads, enabling many threaded request handlers to concurrently match credits with debit requests for funds.

The current available account balance is initially retrieved from the accounts ledger and is split according to the concurrent throughput/demand on the account into a number of chunks of varying sizes which are ordered by decreasing amount. The total value of the credits must equal the available account balance at that point of time.

Each funds control request received into liquidity matching computer program may be immediately checked against a probabilistic data structure (e.g., a Bloom Filter) to determine if it is a duplicate request which has previously altered the account balance. Suspected duplicates are handled outside of the core flow to minimize performance impact.

In step 405, funds control requests received into the liquidity matching computer program are immediately checked against a probabilistic data structure (e.g., a Bloom Filter) to determine if it is a duplicate request which has previously altered the account balance. Suspected duplicates may be handled outside of the core flow to minimize performance impact and may be rejected if found to be a confirmed duplicate.

In step 410, a credit balance may be split into multiple smaller/lower value chunks. In one embodiment, this may be optional as the credit balance may already be split into chunks as part of the initialization process.

In one embodiment, credits/receipts may be added to the credit balance as a new chunk.

In step 415, a thread may handle the debit request and attempts to match the debit request with one or more credit chunks. Any remaining credit that is in excess of the amount required to fund the debit may be returned to the liquidity matching market as one or more new credit chunks, or added to one or more existing credit chunks within the liquidity matching market.

Cancelled debits may be handled as credits/receipts and vice versa.

Requests for new legal holds may be handled in the same way as debits and cancellations of legal holds may be handled in the same way as credits/receipts to impact the available credit funds (liquidity) of the liquidity matching market.

In one embodiment, a list of active holds and their values may be maintained in the state of the liquidity matching market in order to enable the account balance to be derived by adjusting the net balance of the liquidity matching market order book (net of the sum of the credits and debits) to effectively remove the total value of any active holds.

As an illustrative example, thread 1 has received a debit demand for a first quantity of currency units. This demand is added to the debit list. The matching thread scans through the list of available credits. Depending on the requested amount, the thread may choose to start scanning the list of credits from a variable position in the list of credit chunks. For example, starting from the beginning of the ordered list for larger amounts and scanning forward or from the end of the ordered list and scanning backward for smaller amounts. The thread matches the debit demand against the next largest credit in the list, locking the credit object to ensure an atomic linking operation. Failed locking attempts are handled via a retry of the scanning process. The linkage established between the matched debit and the credit.

The difference between the debit and credit amount is appended to the credit list, so that the value can be used by another request.

Continuing with the illustrative example, the second concurrent thread is simultaneously handling a request for a second quantity of currency units. The scan and match work in the same way and a remainder of the first quantity of currency units is appended to the credit list.

In step 420, the state of the liquidity order book is periodically captured and serialized into an object for persistence. The state can be captured frequently (e.g., many times a second) and this can include the outcome of multiple adjustments (debits, credits/receipts, notified pre-approved debits, new/cancelled legal holds, cancelled debits/credits, etc.).

In step 425, the object may then be cryptographically signed and encrypted before persistence into the available liquidity snapshots store, which may be a multi-region distributed database that ensures changes are synchronously replicated out-of-region for enhanced recoverability.

The snapshot can be encrypted and/or signed depending on the data sensitivity and the cryptographic algorithm used (authenticated cyphers provide both privacy and integrity and authenticity protection). It may be stored in a database.

The snapshot may be used for audit and recovery and as the starting point for the next set of debits and other requests to funds control.

In step 430, approved liquidity matches (funded debits), applied credits/receipts, pre-approved debits, cancelled debits/receipts, new/cancelled legal holds and balance changes may be published to the ledger reconciliation computer program and the available liquidity API.

In step 435, the duplicate check state may be updated prior to replying to the money movement platform and after the database write has been successful.

Prior to the response being sent the probabilistic idempotency filter is updated using a hash of attributes pertaining to the activity (e.g., transaction or hold reference number, money movement platform system identifier, account number, amount, etc.) to indicate that account balance(s) and available balance(s) (supply (ies)) have been updated to incorporate the activity. This may be a funded debit request, a pre-approved notification of a debit or a credit/receipt. Applied legal holds may also be incorporated into the duplicate check. Debit requests which were only partially funded may have altered the available balance(s) captured in the liquidity snapshot for this cycle, but as they do not alter the account balance, they are not added to the probabilistic idempotency filter, allowing these debit requests to be re-sent and processed again in the hope that there may now be sufficient liquidity to fully fund these debits. The updated probability idempotency filter can subsequently be used to detect and de-duplicate future requests that have previously altered the account balance(s).

In step 440, the liquidity matching computer program responds to the money movement platform once the state has been captured successfully (e.g., the state could be replicated across multiple datacenters for improved resiliency/recoverability).

In one embodiment, a liquidity allocation monitor may govern how much liquidity should be moved to the liquidity matching market from the algorithm-maintained liquidity snapshot. This may be a configurable amount (or based on activity-current or historic). The liquidity allocation monitor then moves cash/available funds to/from the liquidity matching market as required (e.g., top-up the liquidity matching market when it runs low). This enables the liquidity matching market to benefit from notional borrowing from other accounts (the notional borrowing is handled by the algorithm powered liquidity snapshot engine).

If the liquidity at the liquidity matching market runs low then a liquidity allocation monitor (not shown) may top it up by requesting funds using, for example, the flow of FIG. 3. For example, the flow of FIG. 3 may run concurrently to the liquidity matching market, with a proportion of the account's available funds being handled by the above standalone account flow for certain use cases (e.g., to support the needs of low latency instant payments funds control approvals).

The hybrid liquidity matching computer program may implement a micro-batching algorithm powered liquidity cycle, enabling balance sharing across a group of accounts, which may be in differing currencies or asset classes, plus one or more liquidity matching markets for concurrent processing of funds control requests for an individual account (one liquidity matching market per account).

Debit requests and receipt notifications received for low-value, high-volume and latency sensitive flows (such as instant payments) may be handled by the liquidity matching market, which may be implemented on the same or a different instance of the liquidity matching computer program.

Debit requests and receipt notifications received for high-value flows with lower latency sensitivity (such as wire payments) may be handled by the micro-batching algorithm powered liquidity cycle, which may be hosted by the same or a different instance of the liquidity matching computer program.

The liquidity allocation monitor tracks the available balance(s) maintained by the liquidity matching market(s) (net value of the liquidity matching market order book for an account) and the available balance(s) maintained by the micro-batching algorithm powered liquidity cycle(s), for one or many accounts.

When the available balance drops (or is forecast to drop) below a minimum per-system configured threshold in either the liquidity matching market or the micro-batching algorithm powered liquidity cycle, then the liquidity allocation monitor may make a debit request to the system maintaining the portion of the account balance with an available balance greater than the minimum desired available balance, in order to notionally transfer the available liquidity to the system maintaining the portion of the account balance with an available balance below the minimum desired available balance, via a debit to the former system and a credit to the latter system.

Similarly, when the available balance increases (or is forecast to increase) above a maximum per-system configured threshold in either the liquidity matching market or the micro-batching algorithm powered liquidity cycle, then the liquidity allocation monitor may make a debit request to the system maintaining the portion of the account balance with an available balance exceeding the maximum desired available balance, in order to notionally transfer the available liquidity to the system maintaining the portion of the account balance with an available balance below the maximum desired available balance, via a debit to the former system and a credit to the latter system.

For example, if, according to some configuration or other forecast assessment, the liquidity allocation monitor assesses there to be an insufficient amount of liquidity in the micro-batching algorithm powered liquidity cycle (which may include options for notional borrowing from other client accounts and/or credit lines in its assessment of liquidity) then an amount of available funds may be requested from the liquidity matching market via a debit request made to the liquidity matching market by the liquidity allocation monitor. If this debit request is successfully funded by the liquidity matching market, then the debited funds may be credited to the portion of the account balance maintained by the micro-batching algorithm powered liquidity cycle, thereby increasing the amount of the portion of the account's available balance maintained by the micro-batching algorithm powered liquidity cycle by the absolute value of the debit/credit and reducing the amount of the portion of the account's available balance maintained by the liquidity matching market by the absolute value of the debit/credit.

Likewise, if according some configuration or other forecast assessment, the liquidity allocation monitor assesses there to be an excess amount of liquidity in the micro-batching algorithm powered liquidity cycle (which may include options for notional borrowing from other client accounts and/or credit lines in its assessment of liquidity) then an amount of available funds may be requested from the micro-batching algorithm powered liquidity cycle via a debit request made to the micro-batching algorithm powered liquidity cycle by the liquidity allocation monitor. If this debit request is successfully funded by the micro-batching algorithm powered liquidity cycle, then the debited funds may be credited to the portion of the account balance maintained by the liquidity matching market, thereby increasing the amount of the portion of the account's available balance maintained by the liquidity matching market by the absolute value of the debit/credit and reducing the amount of the portion of the account's available balance maintained by the micro-batching algorithm powered liquidity cycle by the absolute value of the debit/credit.

The state of the liquidity matching market may be persisted on a durable, potentially multi-region, database/storage medium for recovery. The state can be captured frequently (e.g., many times a second) and this can include the outcome of multiple adjustments (credits, debits notified pre-approved debits and legal holds).

Approved liquidity matches (funded debits), applied credits/receipts, pre-approved debits, cancelled debits/receipts, new/cancelled legal holds and balance changes are published to the ledger reconciliation computer program and the available liquidity API.

Responses to the funds control requests are published. Prior to the response being sent the probabilistic idempotency filter is updated to indicate that funds have been allocated to a given request. This can subsequently be used to de-duplicate future requests.

Prior to the response being sent the probabilistic idempotency filter is updated using a hash of attributes pertaining to the activity (e.g., transaction or hold reference number, money movement platform system identifier, account number, amount, etc.) to indicate that account balance(s) and available balance(s) (supply (ies)) have been updated to incorporate the activity. This may be a funded debit request, a pre-approved notification of a debit or a credit/receipt. Applied legal holds may also be incorporated into the duplicate check. Debit requests which were only partially funded may have altered the available balance(s) captured in the liquidity snapshot for this cycle, but as they do not alter the account balance, they are not added to the probabilistic idempotency filter, allowing these debit requests to be re-sent and processed again in the hope that there may now be sufficient liquidity to fully fund these debits. This can subsequently be used to detect and de-duplicate future requests that have previously altered the account balance(s).

To prevent an accumulation of small credits, a process runs periodically to consolidate credits. This is achieved by either adding credit residuals to larger credit items in the list, or by summing the whole credit list and redividing into chunks.

Funds control requests received into liquidity matching computer program are immediately checked against a probabilistic data structure (e.g., a Bloom Filter) to determine if it's a duplicate which has previously altered the account balance. Suspected duplicates are handled outside of the core flow to minimize performance impact and may be rejected if found to be a confirmed duplicate.

In one embodiment, the duplicate check applies to all flows into the liquidity matching engine, regardless of the funds control liquidity matching method used.

According to an embodiment, a method for batched reconciliation is provided according to an embodiment. This provides additional details on steps 226, 228, and 230, above.

Ledger postings and liquidity snapshots are transferred to an in-memory queue structure for subsequent processing by the batch cycle. The queue may take many forms, e.g., a messaging technology like Apache Kafka, Amazon Web Services Simple Queue Service, RabbitMQ, etc.

The matches may be micro-batches, since the ledger reconciliation computer program will need to be able to process a similar volume of activity as the liquidity matching engine. Approved funds control activities may be tracked through to a settled ledger posting event by the ledger reconciliation system. The batch frequency can be adjusted to suit the business needs (the batch cycle need not be as frequent as the liquidity matching engine, provided it can handle larger batches).

A batch cycle starts with the latest reconciliation snapshot from the unposted liquidity snapshots store.

The most recent liquidity snapshots produced by the liquidity matching computer are retrieved from the queue along with unprocessed account ledger(s) (this assumes that the ledger postings are held in a queuing/messaging system from the account ledgers to the ledger reconciliation system). Reconciliation is performed between the funds control funded/approved money movement event and the later settled ledger posting event.

Reconciliation may be achieved using a set of common attributes/data that enables an individual money movement to be reliably and uniquely distinguished by money movement platform 110, funds control system 130 and account ledgers 115 (e.g., transaction reference number, money movement platform identifier, account number, amount, funds control authorization token/identifier, etc.).

In one embodiment, the common reconciliation attribute set may vary by money movement platform 110 and the money movement type and may be present in the funds control request and/or response made by money movement platform 110 to funds control system 130; and in the completed/settled money movement event notification sent by money movement platform 110 to account ledgers 115; and in the completed/settled account ledger posting event notification sent by account ledgers 115 to funds control system 130.

Any unreconciled money movement activity from the batch cycle is serialized into a snapshot object for persistence. This object may be cryptographically signed and may be encrypted using authenticating cyphers, like AES-GCM to achieve both encryption and authentication/integrity protection in one pass before persistence into the unposted liquidity snapshots store, which may be a multi-region distributed database that ensures writes are synchronously replicated out-of-region. The snapshot may be split across multiple rows mitigating database row size limits. A consistent hashing algorithm may be used (e.g., hashing unposted cash activities across multiple rows by the account number to which the money movement activity applies to).

Should a cycle detect a settled money movement ledger posting event that cannot be reconciled with a prior approved funds control request (debit, credit/receipt or a notification of a pre-approved debit), then the ledger reconciliation computer program may send a balance update notification, with the equal and opposite value of the detected ledger posting, to the liquidity matching computer program to ensure the account balances and available balances (supplies) reflect all settled activity recorded by the ledger.

In one embodiment, the funds control system may be sharded for enhanced availability, resiliency and performance. For example, with reference to FIG. 1, funds control system 130 may be implemented as a plurality of deployment partitions that do not share any state, shared components, infrastructure or hardware. The funds control workload may be divided across the deployment partitions according, enabling issues impacting common state (e.g., workflow steps and state store 136, available liquidity snapshot store 144, and unposted liquidity snapshot store 146), or shared components (e.g., database or database schema) or infrastructure/hardware (e.g., datacenter or datacenter availability zone), to be isolated to only clients whose funds control is processed by that specific partition. Thus, if the funds control workload is distributed across multiple funds control system deployment partitions, then only a sub-set of the workload may be impacted in the event of an issue with one deployment, helping to minimize the impact of an issue.

Money movement platform 110 may be provided with a smart load balancer (not shown) to implement this feature. The smart load balancer may sit with the money movement platform, or it could sit with the funds control system as a separate component in-front of funds control workflow orchestrator computer program 134, or in both places (e.g., to help alleviate concerns with eventually consistent state/routing updates).

In embodiments, the smart load balancer may take the form of a computer program and/or bespoke hardware (e.g., a networking routing device a suitably configured field-programmable gate array integrated with a computer, etc.).

A smart load balancer which sits within the funds control system in-front of the funds control workflow orchestrator, may help to configure the funds control components deployed to a physical computer node which it manages. The smart load balancer may monitor the health of the funds control components on its physical node and the health of the underlying infrastructure through the collection of telemetry, computer program execution timings/metrics and physical infrastructure sensor measurements/metrics. If the monitored parameters/metrics go outside of normal bounds, then the smart load balancer may deem the funds control processing node to be unhealthy and it may block any traffic from reaching the funds control components.

In another embodiment, the funds control system deployment partition(s) may be further sharded for horizontal scaling. For example, with reference to FIG. 1, funds control system 130 may be split into a plurality of redundant nodes which may be grouped into logical shards which process funds control requests for a sub-set of clients. The shards may be made horizontally scalable by partitioning the funds control workload into a number of logical partitions based on some well-known funds control request attribute, like the identifier of the client which owns the account. The logical partitions are uniquely mapped to the funds control system deployment shards (to ensure that the balances for accounts and balance sharing groups are only maintained by one shard, to avoid double counting). This enables the funds control system to scale with client growth and enable clients to be processed on independent funds control system instances for enhanced isolation and customized software release change control.

The deployment partition and shard allocated to process a funds control request may be determined by the smart load balancer.

In one embodiment, the smart load balancer may derive both the deployment partition and the logical partition using a consistent hashing algorithm (e.g., Ketama, Rendezvous Hashing, Jump Consistent Hash, etc.). The smart load balancer may implement the consistent hashing algorithm using the configured well-known attribute to determine the logical partition and corresponding deployment partition and processing shard to route the funds control requests to.

The smart load balancer may be deployed to each of several redundant nodes which make-up a processing shard. The smart load balancers on each node may compete to obtain the shard's single exclusive lease. The shard “leaseholder” (the node which holds the exclusive lease for the shard) is designated as the primary processing node for the shard (thereby ensuring that all funds control requests for an account are processed in the same place to avoid double counting, for performance and to ensure that the priorities of concurrent funds control requests are considered within the same micro-batching processing cycle). The leaseholder is required to renew its lease periodically to attest and demonstrate to the other nodes that the node continues to be healthy. If the smart load balancer identifies the node to be unhealthy (e.g., due to a measured/observed computer program, component, infrastructure, etc. degradation or failure) it may relinquish its lease and stop processing funds control requests.

The shard leases may be maintained in a consistent core database, which the smart load balancers may watch to detect a failure of the shard's leaseholder node (which would become evident because of a lease expiry). Should the shard lease expire, the remaining healthy smart load balancers may compete to become the new shard leaseholder and continue processing funds control requests for the client. The consistent core database should exhibit strong serializability and linearizability characteristics and atomic transactions to ensure that leases are allocated reliably and exclusively to a single node. The consistent core database may support multi-region resiliency via a quorum-based consensus protocol (e.g., Raft or Paxos).

After becoming the leaseholder, the smart load balancer may notify the other funds control components (e.g., the funds control workflow orchestrator computer program, the liquidity matching computer program and the ledger reconciliation computer program) that the node is now active. This might trigger each component to refresh its state from the respective shared partition stores (e.g., workflow steps and state store, available liquidity snapshots store and the unposted liquidity snapshots store) in preparation of processing funds control requests and maintain synchronization of balances with the account ledgers.

In one embodiment, before the money movement platform makes a funds availability request to the funds control orchestrator (e.g., step 208), the money movement platform may determine the correct partition to send the request or notification to and may pick a smart load balancer from the partition to connect to. The smart load balancer's Internet Protocol address and request routing rules and configuration may be pre-shared with the money movement platform and other smart load balancers within and across funds control system deployments and shards or retrieved and periodically refreshed at runtime via an API hosted by the funds control system.

If the money movement platform connects to a processing node which is not the primary processing node for the request's corresponding logical partition, then the smart load balancer may redirect the request to the appropriate node so that the request can be processed.

A smart load balancer may determine the Internet Protocol address of the shard leaseholder to route the funds control requests to by reference to the logical partition to shard mapping, current shard leaseholder and node Internet Protocol address data tables maintained by the consistent core.

According to another embodiment, a token may be included in the response from liquidity matching computer program 140, which may be forwarded in the response by funds control workflow orchestrator computer program 134 to money movement platform 110's request. Money movement platform 110 may then use this token in several other systems that it may interact with, such as an external clearing connectivity system (not shown), a distributed transaction tracing/monitoring system (not shown), etc. Money movement platform 110 may then forward this token on to account ledgers 115, which enables a statement/reporting system which obtains postings data from account ledgers 115 to order client activity by same order processed by liquidity matching computer program 140.

The token may encode information relating to the funds control decision (e.g., the amount approved, account number/identifier, funds control authorization expiry time) and should be signed for integrity protection and authenticity. The token could also be encrypted for privacy. Asymmetric keys and public key cryptography and infrastructure may be used for key distribution, validation, revocation, renewal, etc. with the other systems which may need to inspect the funds control token.

Authenticated cyphers (e.g., AES-GCM) enable integrity, authenticity and privacy to be achieved at the same time, thereby helping to improve performance of the funds control system and reduce the size of the token.

In one embodiment, after determining if the request can be funded (e.g., step 214), the liquidity matching computer program may generate a token that may be stored in the available liquidity snapshot store. The token may be any suitable unique identifier. The token may be provided to the ledger reconciliation computer program, which may use the token to perform a reliable reconciliation.

Account ledgers 115 may forward the token to ledger reconciliation computer program 142, which independently received a copy of the token earlier from liquidity matching computer program 140, enabling ledger reconciliation computer program 142 to reliably reconcile the earlier funding decision (or notification of credit/pre-approved debit) against the subsequent ledger posting by comparing the tokens or token identifier. received from the liquidity matching computer program and account ledger.

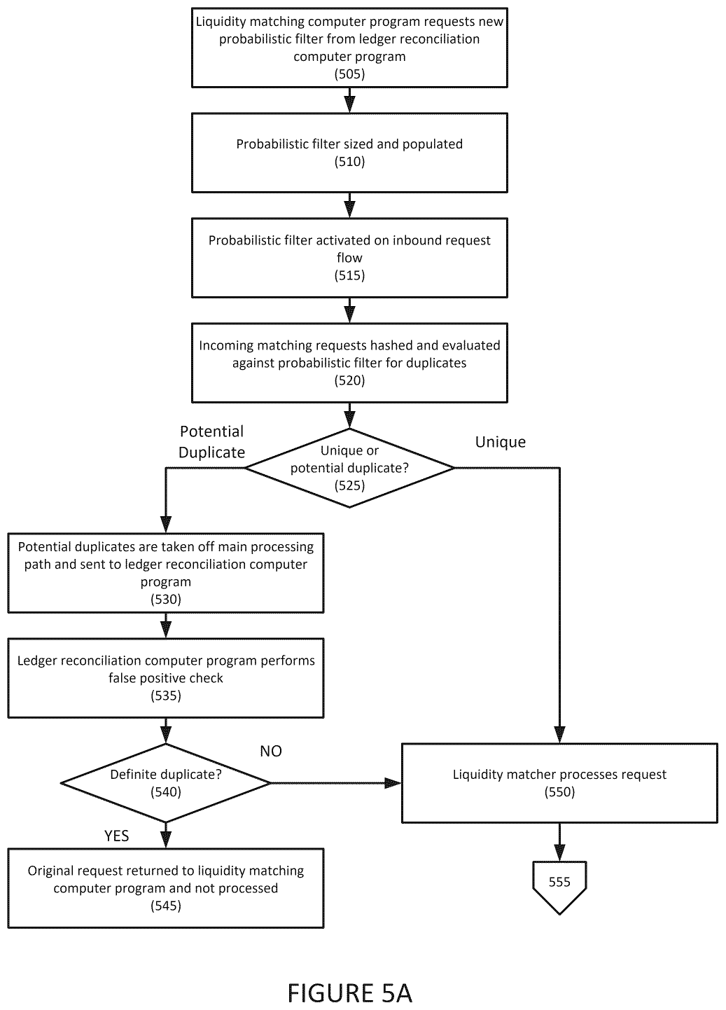

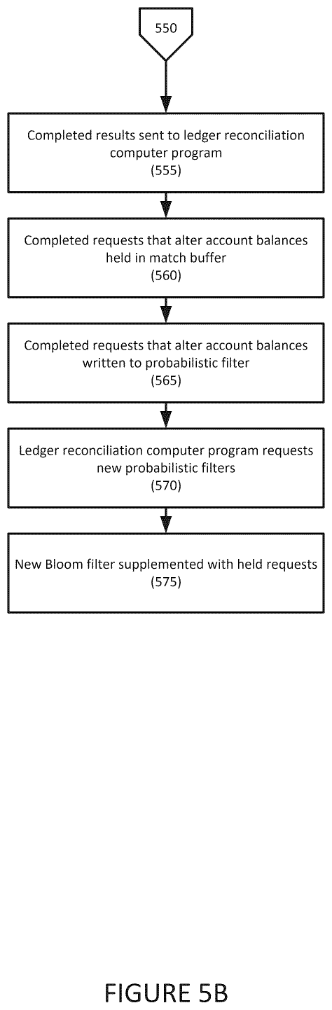

Referring to FIGS. 5A and 5B, in one embodiment, the liquidity matching computer program and the ledger reconciliation computer program may perform high-performance probabilistic idempotency checks. For example, liquidity matching computer program 140 and the ledger reconciliation computer program 142 may ensure that requests from funds control workflow orchestrator computer program 134 that have already impacted the balance stored in available liquidity snapshots store are not applied more than once (within a certain configurable time period).

In one embodiment, the check may be performed when the liquidity matching computer program receives and processes the request (e.g., step 212) or when the liquidity matching computer program is notified of the approved amount of extended credit (e.g., step 240).

In step 505, at application startup, the liquidity matching computer program may request a new probabilistic filter, such as a Bloom filter, from the ledger reconciliation computer program via an API implemented by the ledger reconciliation computer program.

In step 510, the ledger reconciliation computer program may populate the probabilistic filter from the unposted liquidity snapshot store and may size the filter appropriately based on historic data volumes to ensure a consistent false positive rate. The ledger reconciliation computer program may use historic balance impacting activity within the duplicate checking time period to determine the appropriate size.

In step 515, the probabilistic filter may be activated on the inbound request flow of liquidity matching computer program.

In step 520, attributes of incoming funds control requests are hashed and evaluated against the active in-memory probabilistic filter. Example request attributes that could be incorporated in the hash for the duplicate check include the transaction or hold reference number, the money movement platform identifier, the money movement amount, etc. The probabilistic filter will either state a request is definitely unique or a potential duplicate.

In step 525, if the request is a potential duplicate, in step 530, the request is taken off of the main processing path and sent to the ledger reconciliation computer program to evaluate if the request is a genuine duplicate.

In step 535, the false positive check in the ledger reconciliation computer program involves referencing a persistent store, such as the unposted liquidity snapshots store, to determine whether a request has been processed previously during the duplicate check detection time window (e.g., during the prior 24 hours).

To address potential race conditions where the liquidity matching computer program might be ahead of ledger reconciliation computer program, a monotonically increasing sequence number corresponding to the current micro-batch cycle is provided by liquidity matching computer program to ledger reconciliation computer program, in the liquidity snapshots (which record the output of the micro-batch cycle) forwarded to the ledger reconciliation computer program in step 220, above.

When checking if a request is a false positive, the liquidity matching computer program may include its current micro-batch sequence number in its request to the ledger reconciliation computer program. If the ledger reconciliation computer program receives a sequence number that is ahead of its current position, it can employ an exponential backoff strategy, allowing it to wait until it has caught up with liquidity matching computer program before verifying the duplicate, or responding with a failure if the delay is not caught up within a configurable maximum wait and retry period.

In step 540, if the request is a definite duplicate (not a false positive), in step 545, the original response is returned back to liquidity matching computer program and the request is not processed again (although theoretically the request could be re-sent, but it would get trapped and not processed while the request is still included in the temporal history of the Bloom Filter).

In step 550, unique requests and false positives (which have been flagged with an override by ledger reconciliation computer program and returned) are processed in the liquidity matching computer program. For example, the process may start with step 212, above.

In step 555, completed requests which alter the account balance (e.g., approved debit, credit/receipt notification, new legal hold or balance notification) are sent to the ledger reconciliation computer program which updates the unposted liquidity snapshots store.

In step 560, the liquidity matching computer program may hold completed requests that alter the account balance and new legal holds applied to the available balance, in a match buffer to support the Bloom filter renewal process (step 575).

In one embodiment, if a probabilistic data filter is not being renewed/requested, the processed balance impacting event or new legal hold may not be added to the match buffer. In another embodiment, the processed balance impacting event or new legal hold may be removed from the match buffer after a short period of time.

In step 565, the liquidity matching computer program may write completed requests that alter the account balance and new legal holds applied to the available balance, back into the in-memory probabilistic filter inside liquidity matching computer program.

In step 570, if the probabilistic filters are full, or nearly full, the liquidity matching computer program may request new probabilistic filters from the ledger reconciliation computer program based on a sliding time window (e.g., previous 24 hours of activity for the account or balance sharing group). The new probabilistic data filter is pre-populated by the ledger reconciliation computer program with the balance impacting funds control activity for the configured historic sliding time window. The ledger reconciliation computer program will produce an appropriately sized filter based on historic data volumes to achieve a consistent, configurable, false positive rate.

In step 575 when an active filter needs to be switched with a new filter from ledger reconciliation computer program, the new filter may have missed messages which have arrived whilst the switch is in-flight. To remediate this, the new Bloom filter from ledger reconciliation computer program is supplemented with the requests held in the match buffer and processing continues as normal.

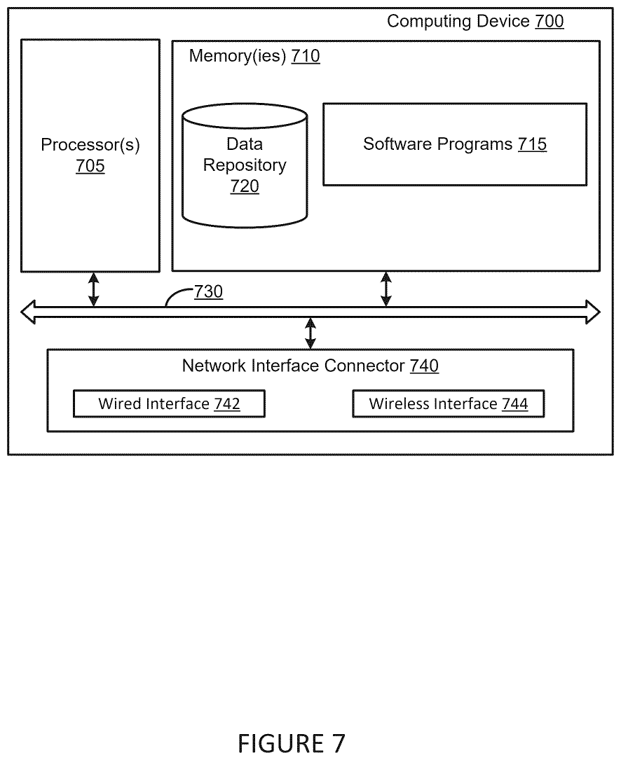

FIG. 7 depicts an exemplary computing system for implementing aspects of the present disclosure. FIG. 7 depicts exemplary computing device 700. Computing device 700 may represent the system components described herein. Computing device 700 may include processor 705 that may be coupled to memory 710. Memory 710 may include volatile memory. Processor 705 may execute computer-executable program code stored in memory 710, such as software programs 715. Software programs 715 may include one or more of the logical steps disclosed herein as a programmatic instruction, which may be executed by processor 705. Memory 710 may also include data repository 720, which may be nonvolatile memory for data persistence. Processor 705 and memory 710 may be coupled by bus 730. Bus 730 may also be coupled to one or more network interface connectors 740, such as wired network interface 742 or wireless network interface 744. Computing device 700 may also have user interface components, such as a screen for displaying graphical user interfaces and receiving input from the user, a mouse, a keyboard and/or other input/output components (not shown).

Additional details are provided in the attached Appendix, the disclosure of which is incorporated, by reference, in its entirety.

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method, comprising:
receiving, by a funds control workflow orchestrator computer program executed by an electronic device and from a money movement platform, a funds control request for a transaction for a client;
requesting, by the funds control workflow orchestrator computer program, funding for the request from a liquidity matching computer program;
determining, by the liquidity matching computer program, whether the request can be funded based on account balances for the client retrieved from or synchronized with an account ledger or an approved credit extension;
generating, by the liquidity matching computer program, a liquidity snapshot for the client and storing the liquidity snapshot in an available liquidity snapshot store;
receiving, by the funds control workflow orchestrator computer program, a positive determination on liquidity;
returning, by the funds control workflow orchestrator computer program, the positive determination to the money movement platform, wherein the money movement platform executes the transaction; and
updating, by the funds control workflow orchestrator computer program, a workflow status.

2. The method of claim 1, wherein the step of determining whether the request can be funded comprises:
retrieving, by the liquidity matching computer program, a prior liquidity snapshot from the available liquidity snapshot store;
extracting, by the liquidity matching computer program, current liquidity information from the prior liquidity snapshot;
executing, by the liquidity matching computer program, a debit funding algorithm to identify debits to fund;
updating, by the liquidity matching computer program, the current liquidity information;
serializing, by the liquidity matching computer program, the updated current liquidity information;
persisting, by the liquidity matching computer program, the serialized updated current liquidity information in the available liquidity snapshots store; and
forwarding, by the liquidity matching computer program, the updated current liquidity information to a ledger reconciliation computer program.

3. The method of claim 2, further comprising:
matching, by the ledger reconciliation computer program, a completed ledger posting event with the request.

4. The method of claim 2, wherein the prior liquidity snapshot comprises available balances, balance sharing rules, funding source priorities, notional borrowing/lending limits, remaining notional borrowing/lending limits amounts, and/or remaining credit line amounts.

5. The method of claim 2, further comprising:
applying, by the liquidity matching computer program, credits/receipts to the current liquidity information; and
returning, by the liquidity matching computer program, cash for partially funded debits from a previous cycle as available credit to a balance sharing group for re-use.

6. The method of claim 1, wherein the liquidity matching computer program processes the request as a plurality of micro-batches.

7. The method of claim 1, further comprising:
requesting, by the funds control workflow orchestrator computer program, a credit line from a credit extension approval system in response to a negative determination on liquidity.

8. The method of claim 1, wherein the step of determining whether the request can be funded comprises:
verifying, by the liquidity matching computer program, that the request is not a duplicate;
transferring, by the liquidity matching computer program, the request to an in-memory queue;
collecting, by the liquidity matching computer program, an account structure for a balance sharing group for the client and a prior liquidity snapshot;
constructing, by the liquidity matching computer program, a mathematical graph representing a current notional borrowing position for the client;
determining, by the liquidity matching computer program, an optimal repayment of notional borrowing and lending using a maximum flow with minimum cost algorithm;
constructing, by the liquidity matching computer program, a mathematical graph that represents a current position of a balance sharing group for the client;
determining, by the liquidity matching computer program, optimal funding decisions using the mathematical graph that represents the current liquidity, permitted notional borrowing/lending and notional borrowing/lending limits of the balance sharing group;
updating, by the liquidity matching computer program, balances in the balance sharing group;
serializing, by the liquidity matching computer program, the balances and persisting the serialized balances; and
publishing, by the liquidity matching computer program, approved liquidity matches to a ledger reconciliation computer program.

9. The method of claim 1, wherein the step of determining whether the request can be funded comprises:
verifying, by the liquidity matching computer program, that the request is not a duplicate;
splitting, by the liquidity matching computer program, a credit balance into credit chunks;
matching, by a thread executed by the liquidity matching computer program, the request with one of the credit chunks;
capturing, by the liquidity matching computer program, a state of a liquidity order book; and
responding, by the liquidity matching computer program, to the money movement platform with a funding decision.

10. The method of claim 9, further comprising:
replenishing, by the liquidity matching computer program, liquidity with additional funds.

11. A system, comprising:
a money movement platform;
an account ledger; and
a funds control system comprising:
a funds control workflow orchestrator computer program;
a liquidity matching computer program; and
an available liquidity snapshots store;
wherein:
the funds control workflow orchestrator computer program is configured to receive a funds control request for a transaction for a client from the money movement platform;
the funds control workflow orchestrator computer program is configured to request funding for the request from the liquidity matching computer program;
the liquidity matching computer program is configured to determine whether the request can be funded based on account balances for the client retrieved from or synchronized with the account ledger or an approved credit extension;
the liquidity matching computer program is configured to generate a liquidity snapshot for the client and to store the liquidity snapshot in the available liquidity snapshots store;
the funds control workflow orchestrator computer program is configured to receive a positive determination on liquidity;
the funds control workflow orchestrator computer program is configured to return the positive determination to the money movement platform;
the money movement platform is configured to execute the transaction; and
the funds control workflow orchestrator computer program is configured to update a workflow status.

12. The system of claim 11, wherein the liquidity matching computer program is configured to determine whether the request can be funded by:
retrieving a prior liquidity snapshot from the available liquidity snapshot store;
extracting current liquidity information from the prior liquidity snapshot;
executing a debit funding algorithm to identify debits to fund;
updating the current liquidity information;
serializing the updated current liquidity information;
persisting the serialized updated current liquidity information in the available liquidity snapshots store; and
forwarding the updated current liquidity information to a ledger reconciliation computer program.

13. The system of claim 12, further comprising a ledger reconciliation computer program that is configured to match a completed ledger posting event with the request.

14. The system of claim 12, wherein the prior liquidity snapshot comprises available balances, balance sharing rules, funding source priorities, notional borrowing/lending limits, remaining notional borrowing/lending limits amounts, and/or remaining credit line amounts.

15. The system of claim 12, wherein:
the liquidity matching computer program is configured to apply credits/receipts to the current liquidity information; and
the liquidity matching computer program is configured to return cash for partially funded debits from a previous cycle as available credit to a balance sharing group for re-use.

16. The system of claim 11, wherein the liquidity matching computer program is configured to processes the request as a plurality of micro-batches.

17. The system of claim 11, wherein the funds control workflow orchestrator computer program is further configured to request a credit line from a credit extension approval system in response to a negative determination on liquidity.

18. The system of claim 11, wherein the liquidity matching computer program is configured to determine whether the request can be funded by:
verifying that the request is not a duplicate;
transferring the request to an in-memory queue;
collecting an account structure for a balance sharing group for the client and a prior liquidity snapshot;
constructing a mathematical graph representing a current notional borrowing position for the client;
determining an optimal repayment of notional borrowing and lending using a maximum flow with minimum cost algorithm;
constructing a mathematical graph that represents a current position of a balance sharing group for the client;
determining optimal funding decisions using the mathematical graph that represents the current liquidity, permitted notional borrowing/lending and notional borrowing/lending limits of the balance sharing group;
updating the balances, available balances, notional borrowing/lending amounts and remaining notional borrowing/lending limits of the balance sharing group;
serializing and then persisting the balances, available balances, notional borrowing/lending amounts and remaining notional borrowing/lending limits; and
publishing approved liquidity matches to a ledger reconciliation computer program.

19. The system of claim 11, wherein the liquidity matching computer program is configured to determine whether the request can be funded by:
verifying that the request is not a duplicate;
splitting a credit balance into credit chunks;
matching the request with one of the credit chunks;
capturing a state of a liquidity order book; and
responding to the money movement platform with a funding decision.

20. The system of claim 19, wherein the liquidity matching computer program is further configured to replenish liquidity with additional funds.
